(19) United States
(12) Patent Application Publication
(10) Pub. No.: US 2026/0073702 A1
(43) Pub. Date: Mar. 12, 2026

(54) SYSTEMS AND METHODS FOR PREDICTING OCCUPANCY IN A VOXEL REPRESENTATION OF AN ENVIRONMENT

(71) Applicant: QUALCOMM Incorporated, San Diego, CA (US)

(72) Inventors: Yunxiao SHI, San Diego, CA (US); Hong CAI, San Diego, CA (US); Amin ANSARI, Kirkland, WA (US); Fatih Murat PORIKLI, San Diego, CA (US); Avdhut JOSHI, San Marcos, CA (US); Ahmed Kamel SADEK, San Diego, CA (US)

(21) Appl. No.: 18/913,900

(22) Filed: Oct. 11, 2024

Related U.S. Application Data
(60) Provisional application No. 63/693,123, filed on Sep. 10, 2024.

(51) Int. Cl. G06V 20/56; G06T 7/55; G06V 10/764

(52) U.S. Cl. CPC G06V 20/56; G06T 7/55; G06V 10/764; G06T 2207/20081

(57) ABSTRACT

Imaging systems and techniques are described. In some examples, an imaging system extracts a plurality of features from the plurality of images of an environment. The plurality of images include different perspectives on the environment. The imaging system processes the plurality of features to generate a voxel-based representation of the environment. The voxel-based representation includes a plurality of voxels. The imaging system analyzes the plurality of images and the voxel-based representation to classify a first subset of the plurality of voxels into a first object category and to classify a second subset of the plurality of voxels into a second object category.

### CROSS-REFERENCE TO RELATED APPLICATIONS

This application claims the benefit of U.S. Provisional Application No. 63/693,123, filed Sep. 10, 2024, and titled “Systems and Methods for Predicting Occupancy in a Voxel Representation of an Environment,” which is hereby incorporated by reference in its entirety and for all purposes.

### FIELD

This application is related to imaging. More specifically, this application relates to systems and methods for automatically predicting a focus occupancy and/or semantic label using a machine learning model.

### BACKGROUND

Many devices include one or more cameras. For example, a smartphone or tablet includes a front facing camera to capture selfie images and a rear facing camera to capture an image of a scene (such as a landscape or other scenes of interest to a device user). A camera can capture images using an image sensor of the camera, which can include an array of photodetectors. Some devices can analyze image data captured by an image sensor to detect an object within the image data. Sometimes, cameras can be used to capture images of scenes that include one or more people.

### BRIEF SUMMARY

Imaging systems and techniques are described. In some examples, an imaging system extracts a plurality of features from the plurality of images of an environment. The plurality of images include different perspectives on the environment. The imaging system processes the plurality of features to generate a voxel-based representation of the environment. The voxel-based representation includes a plurality of voxels. The imaging system analyzes the plurality of images and the voxel-based representation to classify a first subset of the plurality of voxels into a first object category and to classify a second subset of the plurality of voxels into a second object category.

In another example, an apparatus is provided that includes one or more memories and one or more processors coupled to the one or more memories. The at least one processor is configured to: extract a plurality of features from a plurality of images of an environment, wherein the plurality of images include different perspectives on the environment; process the plurality of features to generate a voxel-based representation of the environment, wherein the voxel-based representation includes a plurality of voxels; and analyze the plurality of images and the voxel-based representation to classify a first subset of the plurality of voxels into a first object category and to classify a second subset of the plurality of voxels into a second object category.

According to at least one example, a method is provided. The method includes: extracting a plurality of features from a plurality of images of an environment, wherein the plurality of images include different perspectives on the environment; processing the plurality of features to generate a voxel-based representation of the environment, wherein the voxel-based representation includes a plurality of voxels; and analyzing the plurality of images and the voxel-based representation to classify a first subset of the plurality of voxels into a first object category and to classify a second subset of the plurality of voxels into a second object category.

In another example, a non-transitory computer-readable medium is provided that has stored thereon instructions that, when executed by one or more processors, cause the one or more processors to: extract a plurality of features from the plurality of images of an environment, wherein the plurality of images include different perspectives on the environment; process the plurality of features to generate a voxel-based representation of the environment, wherein the voxel-based representation includes a plurality of voxels; and analyze the plurality of images and the voxel-based representation to classify a first subset of the plurality of voxels into a first object category and to classify a second subset of the plurality of voxels into a second object category.

In another example, an apparatus for imaging is provided. The apparatus includes: means for extracting a plurality of features from a plurality of images of an environment, wherein the plurality of images include different perspectives on the environment; means for processing the plurality of features to generate a voxel-based representation of the environment, wherein the voxel-based representation includes a plurality of voxels; and means for analyzing the plurality of images and the voxel-based representation to classify a first subset of the plurality of voxels into a first object category and to classify a second subset of the plurality of voxels into a second object category.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of an image capture and processing system, in accordance with some examples;

FIG. 2 is a conceptual diagram illustrating examples of images and corresponding semantic maps, in accordance with some examples;

FIG. 3 is a block diagram illustrating an imaging system that processes images of an environment using ML model(s) to generate a 3D occupancy prediction map of the environment, in accordance with some examples;

FIG. 4 is a block diagram illustrating an imaging system that includes ML model(s) that can be trained, using heterogeneous multi-task supervision, to process images of an environment to generate a 3D occupancy prediction map of the environment, 2D depth maps of the environment, and/or 2D semantic maps of the environment, in accordance with some examples;

FIG. 5 is a block diagram illustrating examples of types of inputs to an imaging system, such as images, 2D depth maps, 2D semantic maps, surface normal, local planar priors, and/or edge priors, in accordance with some examples;

FIG. 6 is a conceptual diagram illustrating a technique for 3D volume construction via feature averaging, in accordance with some examples;

FIG. 7 is a birds-eye view diagram illustrating a vehicle along with images captured using sensors coupled to the vehicle, in accordance with some examples;

FIG. 8A is a conceptual diagram illustrating images of an environment and classified voxels representing the environment while a vehicle is in a first position in the environment, in accordance with some examples;

FIG. 8B is a conceptual diagram illustrating images of the environment and classified voxels representing the environment while the vehicle is in a second position in the environment, in accordance with some examples;

FIG. 8C is a conceptual diagram illustrating images of the environment and classified voxels representing the environment while the vehicle is in a third position in the environment, in accordance with some examples;

FIG. 8D is a conceptual diagram illustrating images of the environment and classified voxels representing the environment while the vehicle is in a fourth position in the environment, in accordance with some examples;

FIG. 9 is a block diagram illustrating a machine learning system for training, use (e.g., inference), and updating (e.g., further training) of machine learning (ML) model(s) associated with an ML prediction engine for processing images of an environment to extract features, to generate a voxel representation of the environment, to determine classifications of the voxels in the voxel representation, to generate updates to the voxel representation, to generate depth map(s) of the environment, and/or to generate semantic map(s) of the environment, in accordance with some examples;

FIG. 10 is a block diagram illustrating an example of a neural network that can be used for imaging operations, in accordance with some examples;

FIG. 11A is a perspective diagram illustrating a head-mounted display (HMD) that is used as part of an imaging system, in accordance with some examples;

FIG. 11B is a perspective diagram illustrating the head-mounted display (HMD) of FIG. 11A being worn by a user, in accordance with some examples;

FIG. 12A is a perspective diagram illustrating a front surface of a mobile handset that includes front-facing cameras and that can be used as part of an imaging system, in accordance with some examples;

FIG. 12B is a perspective diagram illustrating a rear surface of a mobile handset that includes rear-facing cameras and that can be used as part of an imaging system, in accordance with some examples;

FIG. 13 is a perspective diagram illustrating a vehicle that includes various sensors and that can be used as part of an imaging system, in accordance with some examples;

FIG. 14A is a perspective diagram illustrating an unmanned ground vehicle (UGV) that can be used as part of an imaging system, in accordance with some examples;

FIG. 14B is a perspective diagram illustrating an unmanned aerial vehicle (UAV) that can be used as part of an imaging system, in accordance with some examples;

FIG. 15 is a flow diagram illustrating a process for imaging, in accordance with some examples; and

FIG. 16 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

A device that includes a camera can analyze image data captured by an image sensor to detect, recognize, classify, and/or track an object within the image data. For instance, by detecting and/or recognizing an object in multiple video frames of a video, the device can track movement of the object over time.

Imaging systems and techniques are described. In some examples, an imaging system extracts a plurality of features from the plurality of images of an environment. The plurality of images include different perspectives on the environment. The imaging system processes the plurality of features to generate a voxel-based representation of the environment. The voxel-based representation includes a plurality of voxels. The imaging system analyzes the plurality of images and the voxel-based representation to classify a first subset of the plurality of voxels into a first object category and to classify a second subset of the plurality of voxels into a second object category.

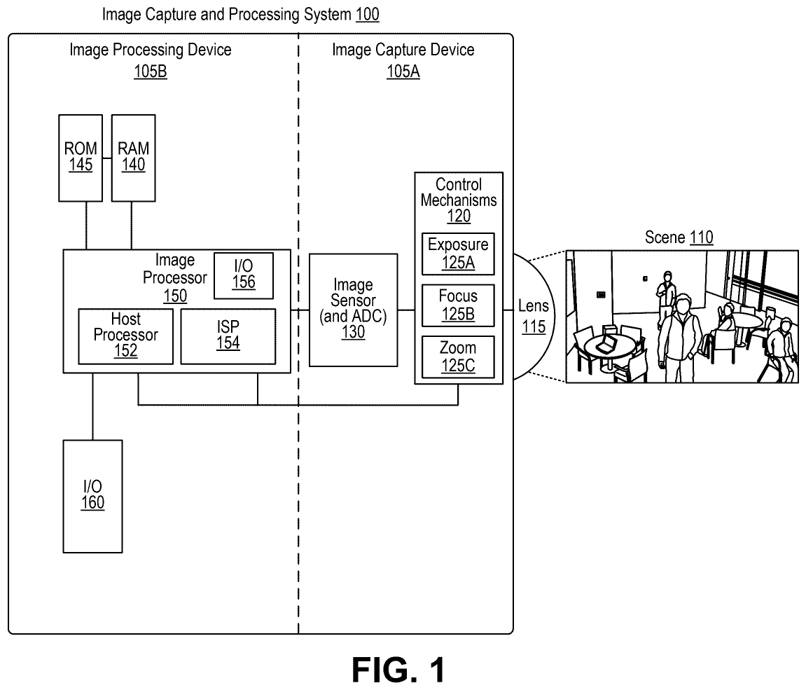

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1610 discussed with respect to the computing system 1600. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1620, read-only memory (ROM) 145 and/or 1625, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1635, any other input devices 1645, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the system 100 and one or more peripheral devices, over which the system 100 may receive data from the one or more peripheral device and/or transmit data to the one or more peripheral devices. The I/O devices 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1602.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

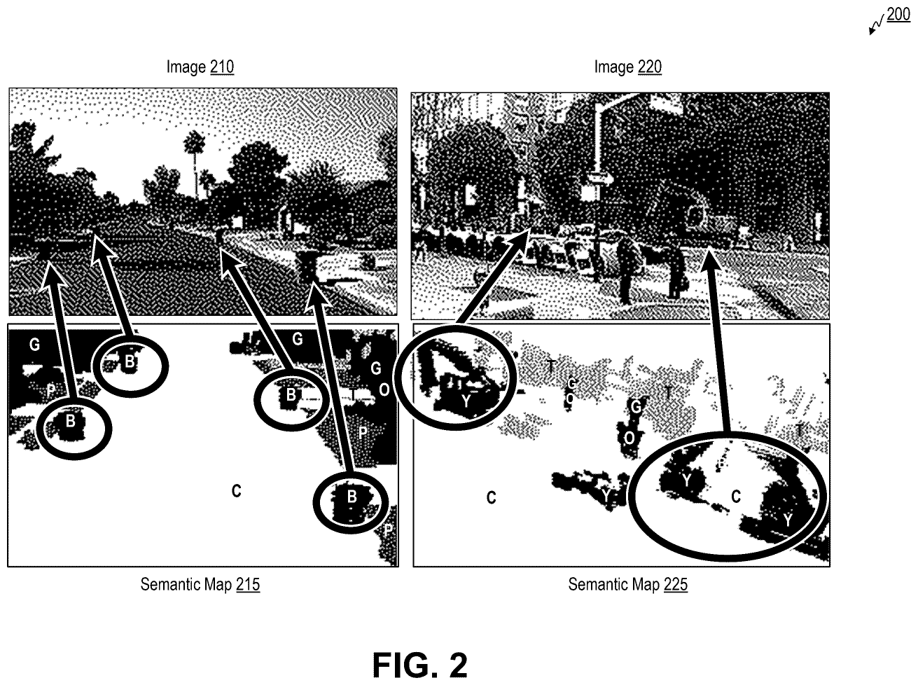

FIG. 2 is a conceptual diagram 200 illustrating examples of images (e.g., image 210, image 220) and corresponding semantic maps (e.g., semantic map 215, semantic map 225). Semantic maps can be used for object detection and/or object recognition, for instance to categorize objects in image(s) into object categories. For instance, the conceptual diagram 200 includes an image 210 of a suburban street on a trash pickup day, with trash bins and/or recycling bins at the edges of the street. The semantic map 215 categorizes the different pixels of the image 210 of the suburban street (or a similar image of the same scene from a slightly different perspective) into different object categories. For instance, in the semantic map 215, cyan (labeled “C”) represents the asphalt and/or concrete (e.g., the street, sidewalks, and/or driveways), green (labeled “G”) represents plants (e.g., trees, bushes, and/or other plants), purple (labeled “P”) represents dirt and/or grass, tan (labeled “T”) represents structures (e.g., man-made structures such as buildings or houses or fences), orange (labeled “O”) represents tree trunks, and black (labeled “B”) represents out-of-vocabulary objects (also known as unlabeled objects). The trash bins and/or recycling bins at the edges of the street in the image 210 are out-of-vocabulary objects and therefore represented as black blobs in the semantic map 215. In some examples, a different color scheme may be used, with different colors representing different categories of objects and/or occupancy states

The image 220 depicts an urban scene with streets between tall buildings, construction barriers, and construction vehicles such as an excavator with an excavator bucket at the end of an excavator arm (e.g., with a boom and dipper). The semantic map 225 categorizes the different pixels of the image 220 of the urban scene (or a similar image of the same scene from a slightly different perspective) into different object categories. For instance, in the semantic map 225, cyan (labeled “C”) represents the asphalt and/or concrete (e.g., the street and/or sidewalks), green (labeled “G”) represents plants (e.g., trees, bushes, and/or other plants), yellow (labeled “Y”) represents construction vehicles and/or equipment, tan (labeled “T”) represents structures (e.g., man-made structures such as buildings or houses or fences), orange (labeled “O”) represents tree trunks, and blue (labeled “B”) represents people. For instance, the excavators in the image 220 are mostly mapped to the color yellow in the semantic map 225, indicating that they are construction vehicles and/or equipment. However, portions of the arm of the excavator are incorrectly mapped to the color cyan (indicating asphalt and/or concrete) rather than the color yellow (indicating construction vehicles and/or equipment) due to the unusual shape of the excavator arm. In some examples, a different color scheme may be used, with different colors representing different categories of objects and/or occupancy states

3D perception is crucial for vision-based robotic systems such as autonomous driving. 3D perception can include 3D object detection. In some examples, 3D object detection estimates 3D locations and dimensions (e.g., via bounding boxes) of objects in predetermined object classes. For instance, each object can be classified via one or more bounding boxes. In some examples, different parts of a larger object can be bound by their own bounding box to represent objects that are non-rectangular in shape. However, while bounding box representations are compact, the level of expressiveness (and/or level of accuracy) can be restricted.

3D bounding box representations of objects have a number of limitations. For instance, 3D bounding box representations can have issues with dealing with out-of-vocabulary objects. For instance, the trash bins and/or recycling bins at the edges of the street in the image 210 are out-of-vocabulary objects and therefore represented as black blobs in the semantic map 215. In some classification systems, out-of-vocabulary objects are treated as unobserved areas and are essentially ignored. This can be problematic. For instance, if a 3D perception is used to route a vehicle (e.g., a self-driving autonomous vehicle), it would be dangerous for the vehicle to hit any object, including out-of-vocabulary objects such as the trash bins and/or recycling bins at the edges of the street in the image 210. The systems and methods described further herein improve over such systems by identifying and/or predicting which volumes in a 3D environment are occupied or unoccupied (free), so that even if a specific volume has an out-of-vocabulary object (e.g., the trash bins and/or recycling bins), the specific volume is still labeled as occupied if there is a physical object occupying the specific volume or unoccupied (free) if there is no physical object occupying the specific volume.

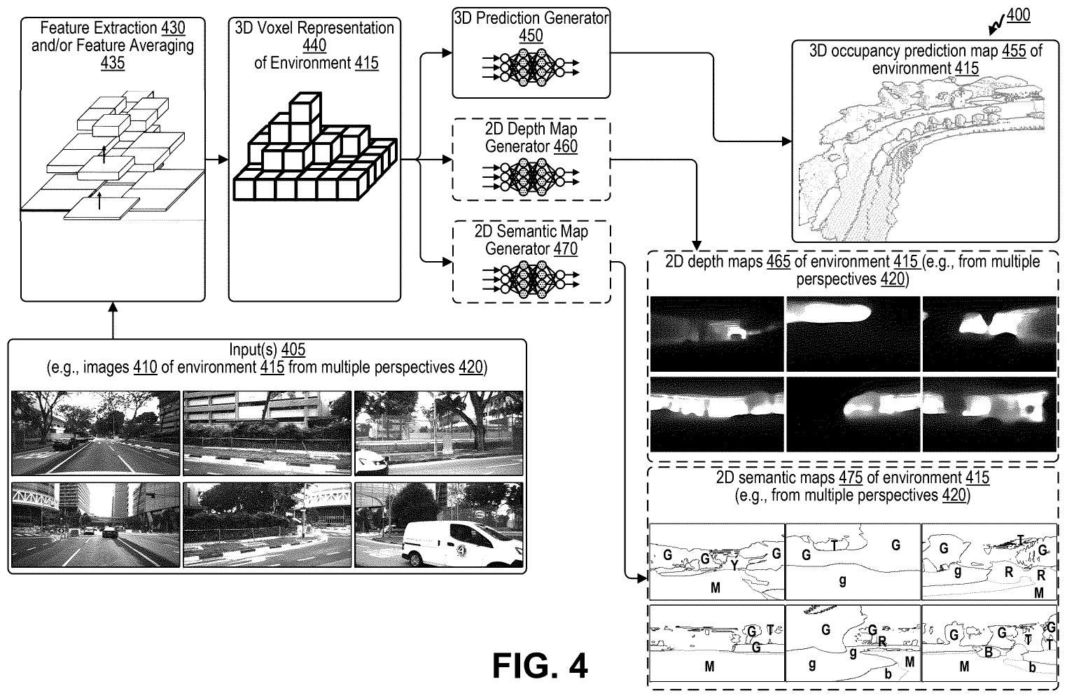

Another limitation of 3D bounding box representations of objects can be erasure of geometric details of certain objects. Bounding boxes can fail to accurately represents geometry of irregularly-shaped objects (e.g., objects that are not rectangular). For instance, in the semantic map 225, portions of the arm of the excavator (visible in the image 220) are incorrectly mapped to the color cyan (indicating asphalt and/or concrete) rather than the color yellow (indicating construction vehicles and/or equipment) due to the unusual shape of the excavator arm. This can be problematic. For instance, if a 3D perception is used to route a vehicle (e.g., a self-driving autonomous vehicle), it would be dangerous for the vehicle to hit any portion of any object, regardless of the geometry of the object, including objects with irregular geometry such as the arm of the excavator in the image 210. The systems and methods described further herein improve over such systems by modeling objects using voxel-based object detection and mapping. In some examples, the voxel-based object detection and mapping is performed using trained machine learning (ML) model(s) that are trained through multi-modal supervision (e.g., along with ML model(s) that generate depth maps and/or semantic maps as in FIG. 4).

Another limitation of 3D bounding box representations of objects can be ineffective representation of large objects, such as surfaces of roads. The systems and methods described further herein improve over such systems by modeling objects using voxel-based object detection and mapping. In some examples, the voxel-based object detection and mapping is performed using trained machine learning (ML) model(s) that are trained through multi-modal supervision (e.g., along with ML model(s) that generate depth maps and/or semantic maps as in FIG. 4).

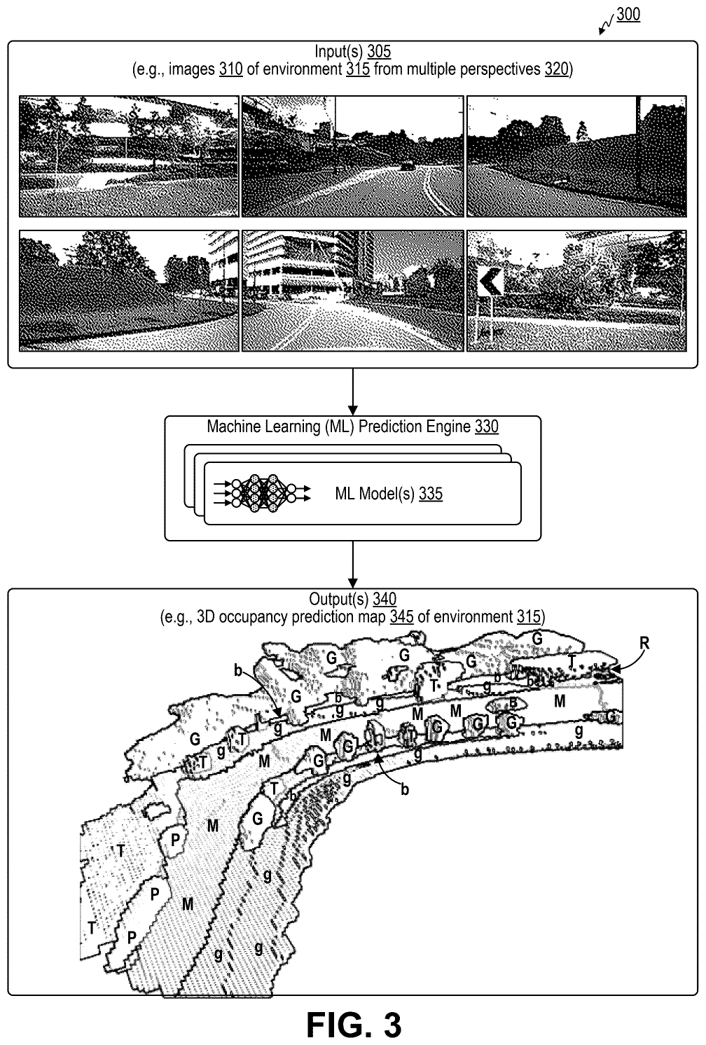

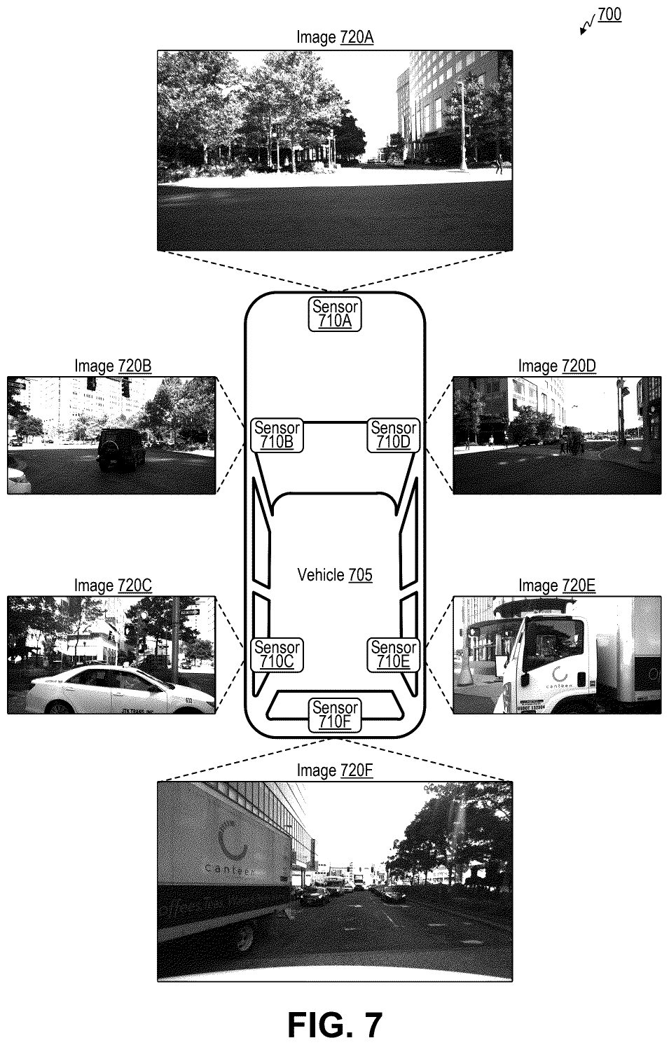

FIG. 3 is a block diagram illustrating an imaging system 300 that processes images 310 of an environment 315 using ML model(s) 335 to generate a 3D occupancy prediction map 345 of the environment 315. The imaging system 300 can include a ML prediction engine 330 that includes one or more ML model(s) 335 that receive and process input(s) 305 to generate output(s) 340. The input(s) 305 can include images 310 of an environment 315 taken from multiple perspectives 320. In some examples, the images 310 can be captured by different cameras (and/or other sensors) that are coupled to a vehicle and that have different poses (e.g., coupled to the vehicle at different positions, having different orientations and therefore facing different directions, or a combination thereof). The cameras can be examples of the image capture and processing system 100 and/or the image capture device 105A, or vice versa. The different perspectives 320 can correspond to the different poses of the different cameras and/or other sensors. For instance, FIG. 7 illustrates a vehicle 705 with multiple sensors 710A-710F that are coupled to the vehicle 705 at different positions and that capture images 720A-720F having different perspectives (e.g., the perspectives 320).

The output(s) 340 include a 3D occupancy prediction map 345 of the environment 315, which the ML model(s) 335 generate based on the input(s) 305 (e.g., based on the images 310). In some examples, the ML model(s) 335 can be trained to generate the 3D occupancy prediction map 345 of the environment 315 to model the detailed geometry and semantics of objects, for objects that are in-vocabulary and for objects that are out-of-vocabulary. The 3D occupancy prediction map 345 of the environment 315 includes a representation and categorization of every voxel in the 3D space of the environment 315. In some examples, the ML model(s) 335 can be trained to generate the 3D occupancy prediction map 345 of the environment 315 jointly estimate the occupancy state and semantic label of each voxel in the environment 315 from the input(s) 305 (e.g., the images 310 of the environment 315). For instance, the ML model(s) 335 can generate the 3D occupancy prediction map 345 of the environment 315 so that each voxel is labeled as occupied (e.g., by a solid material, a liquid material, and/or another physical object), free (e.g., unoccupied, or just occupied by gas), or unobserved (e.g., not pictured in any of the images 310 or any other input(s) 305). In some examples, the ML model(s) 335 can generate the 3D occupancy prediction map 345 of the environment 315 so that each voxel is also labeled with an object type. For instance, in the 3D occupancy prediction map 345 illustrated in FIG. 3, voxels colored in magenta (labeled “M”) represent driveable surfaces (e.g., asphalt), voxels colored in light green (labeled “g”) represent terrain (e.g., grass or dirt), voxels colored in dark green (labeled “G”) represent vegetation (e.g., trees, bushes), voxels colored in tan (labeled “T”) represent structures (e.g., buildings or other man-made structures), voxels colored in blue (labeled “B”) represent cars, voxels colored in purple (labeled “P”) represent trucks, voxels colored in red (labeled “R”) represent people (e.g., pedestrians), and voxels colored in brown (labeled “b”) represent non-vehicle paths (e.g., hiking trails, biking trails, sidewalks). In some examples, a different color scheme may be used, with different colors representing different categories of objects and/or occupancy states. In some examples, certain colors may represent other categories of objects, such as barriers, bicycles, buses, trains, construction vehicles, motorcycles, traffic cones, trailers, other flat surfaces, unobserved areas, and/or out-of-vocabulary objects. In the 3D occupancy prediction map 345, the out-of-vocabulary objects are considered general objects (GO)—that is, occupied, but without a semantic label as to object type that is more specific than being occupied.

In some examples, the ML model(s) 335 can generate other output(s) 340 (instead of or in addition to the 3D occupancy prediction map 345) based on the input(s) 305. For instance, the output(s) 340 can include two-dimensional (2D) depth maps of the environment 315 from the perspectives 320 (e.g., 2D depth maps 465 of the environment 415 from the perspectives 420) and/or 2D semantic maps of the environment 315 from the perspectives 320 (e.g., 2D semantic maps 475 of the environment 415 from the perspectives 420).

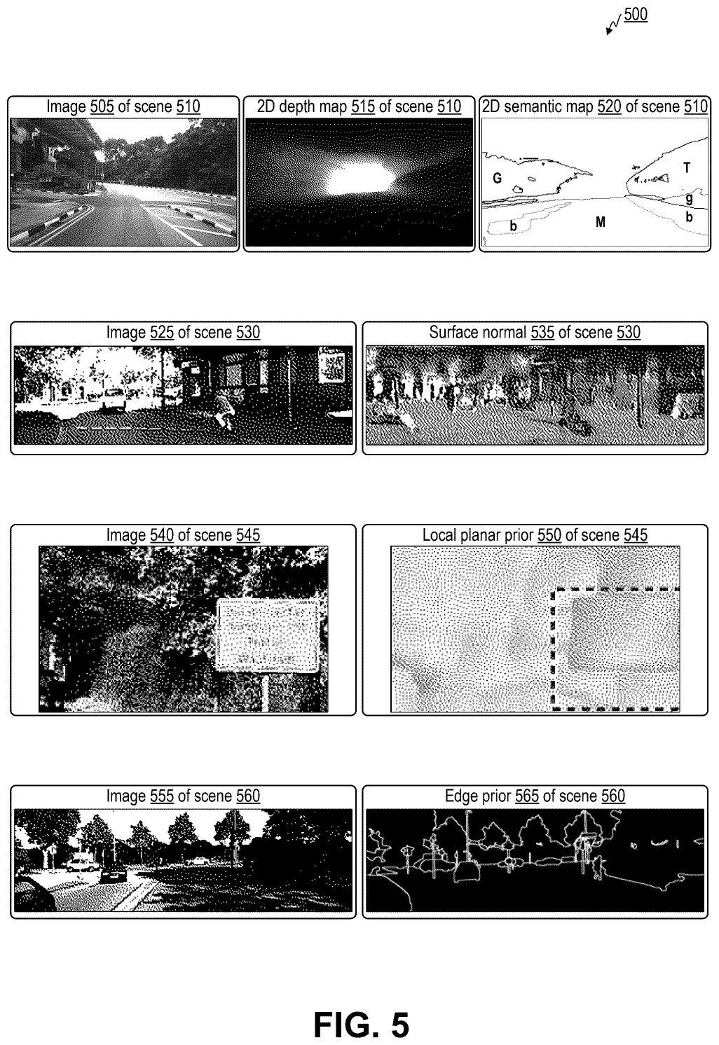

In some examples, the ML model(s) 335 can generate the output(s) 340 based on other input(s) 305 (instead of or in addition to the images 310). For instance, the input(s) 305 can include metadata associated with the images 310 (e.g., indicating which camera each of the images 310 is captured by and a pose of the camera), depth maps (e.g., 2D depth map 515), semantic maps (e.g., 2D semantic map 520), surface normals (e.g., surface normal 535), local planar priors (e.g., local planar prior 550), edge priors (e.g., edge prior 565), depth data such as point clouds (e.g., captured using a depth sensor such as radio detection and ranging (RADAR), light detection and ranging (LiDAR), sound detection and ranging (SODAR), sound navigation and ranging (SONAR), time of flight (ToF) sensors, structured light sensors), any of the types of input(s) illustrated in FIG. 5, any of the types of input(s) discussed herein, or a combination thereof.

Use of the ML model(s) 335 to automatically generate a 3D occupancy prediction map 345 can enable real-time or near-real-time use of the 3D occupancy prediction map 345 for tasks such as routing of an autonomous vehicle. Annotation (e.g., semantic labeling) of image data can take a significant amount of time to perform manually. For instance, in some examples, annotating 30,000 frames of images manually can take 40,000 hours for a person to do manually. The slow pace of manual annotation (e.g., semantic labeling) of image data is incompatible with certain tasks, such as routing of an autonomous vehicle, where a vehicle needs to know what to do at a certain point before the vehicle arrives at that point. This is especially true for cameras with high frame rates (e.g., 60 fps, 90 fps, 120 fps, 240 fps) and/or high resolutions (e.g., 2K, 4K, 8K). Furthermore, manual annotation (e.g., semantic labeling) of image data can result in ambiguous or inconsistent labeling, as different people might label or categorize different objects in slightly different ways. On the other hand, the ML model(s) 335 can be trained to consistently and unambiguously determine both an occupancy state (e.g., occupied, free, or unobserved) and a semantic label (e.g., street, plant, vehicle, building, construction equipment, water, person, bicyclist, and/or general objects) for each voxel of the 3D occupancy prediction map 345.

FIG. 4 is a block diagram illustrating an imaging system 400 that includes ML model(s) that can be trained, using heterogeneous multi-task supervision, to process images 410 of an environment 415 to generate a 3D occupancy prediction map 455 of the environment 415, 2D depth maps 465 of the environment 415, and/or 2D semantic maps 475 of the environment 415. The imaging system 400 can be an example of the imaging system 300. The imaging system 400 processes input(s) 405, which can include images 410 of an environment 415 taken from multiple perspectives 420. In some examples, the images 410 can be captured by different cameras (and/or other sensors) that are coupled to a vehicle and that have different poses (e.g., coupled to the vehicle at different positions, having different orientations and therefore facing different directions, or a combination thereof). The cameras can be examples of the image capture and processing system 100 and/or the image capture device 105A, or vice versa. The different perspectives 420 can correspond to the different poses of the different cameras and/or other sensors. For instance, FIG. 7 illustrates a vehicle 705 with multiple sensors 710A-710F that are coupled to the vehicle 705 at different positions and that capture images 720A-720F having different perspectives (e.g., the perspectives 420).

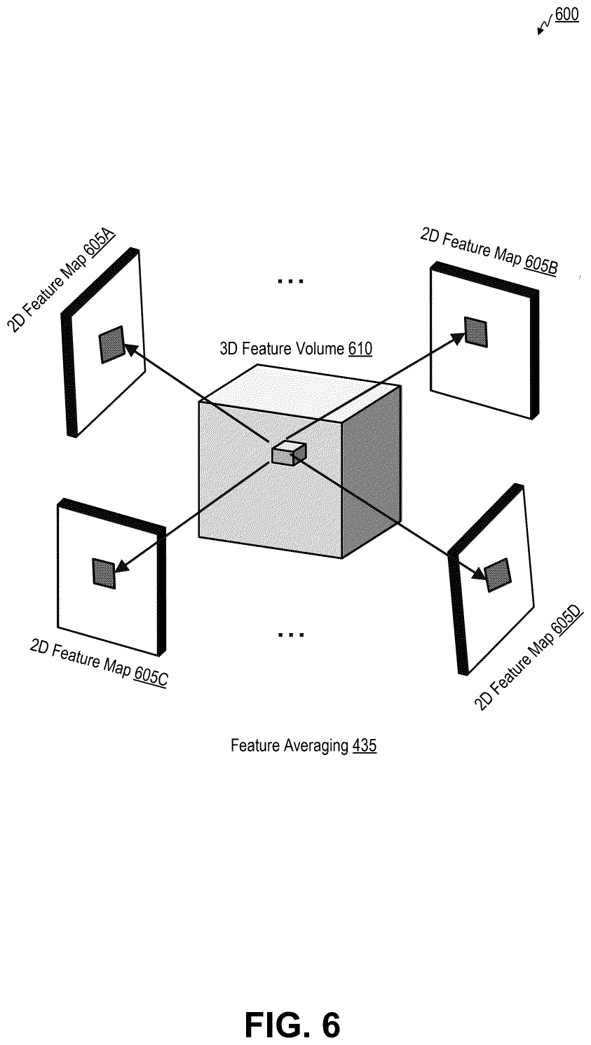

The imaging system 400 processes the input(s) 405 (e.g., the images 410 of the environment 415 from the perspectives 420) using feature extraction 430 to extract features from each of the images 410. In some examples, the imaging system 400 uses a residual neural network (ResNet) to perform feature extraction 430 on the images 410 to extract the features from the images 410. The imaging system 400 processes the features (extracted using the feature extraction 430) based on the perspectives 420 (on the environment 415 of the images 410) using feature averaging 435 to generate a 3D voxel representation 440 of the environment 415. A further example of feature averaging 435 is illustrated in FIG. 6. In some examples, to perform feature averaging 435, the imaging system 400 projects rays from the perspectives 420 (e.g., determined from camera intrinsics) to the features (extracted using the feature extraction 430) into the voxel space to identify locations of voxels (corresponding to specific features) in the voxel space to generate the 3D voxel representation 440 of the environment 415. In some examples, to perform feature averaging 435, the imaging system 400 uses bilinear interpolation to average feature locations corresponding to different perspectives 420 (e.g., for the same feature extracted from different images 410 of the environment 415). In some examples, feature averaging 435 can be referred to as grid sampling, and/or can be performed using grid sampling layers of a machine learning model. In some examples, the imaging system 400 performs feature averaging 435 (e.g., grid sampling) efficiently, without use of attention (e.g., cross-view attention, cross-attention) layers.

The imaging system 400 includes a 3D prediction generator 450 that analyzes the 3D voxel representation 440 of the environment 415 using information from the input(s) 405 (e.g., the images 410 of the environment 415 from the perspectives 420) to generate a 3D occupancy prediction map 455 of the environment 415. To generate the 3D occupancy prediction map 455, the 3D prediction generator 450 can analyze the 3D voxel representation 440 of the environment 415 using information from the input(s) 405 (e.g., the images 410 of the environment 415 from the perspectives 420) to predict an occupancy state or occupancy category of each voxel (e.g., occupied, free, or unobserved), to predict a semantic label or semantic category of each voxel (e.g., driveable surfaces, terrain, vegetation, structures, cars, trucks, people, non-vehicle paths, barriers, bicycles, buses, trains, construction vehicles, motorcycles, traffic cones, trailers, other flat surfaces, unobserved areas, general objects, and/or out-of-vocabulary objects), to modify the voxels of the 3D voxel representation 440 (e.g., to occupy a voxel that was empty/free, to remove a voxel that was occupied, and/or to move a voxel), to modify the 3D voxel representation 440 in other ways, or a combination thereof. All of these predictions by the 3D prediction generator 450 can be output in the form of the 3D occupancy prediction map 455.

In some examples, the imaging system 400 includes a 2D depth map generator 460 that analyzes the 3D voxel representation 440 of the environment 415 using information from the input(s) 405 (e.g., the images 410 of the environment 415 from the perspectives 420) to generate 2D depth maps 465 of the environment 415. The 2D depth maps 465 of the environment 415 can include representations of depth in the environment 415 from the same perspectives 420 as the images 410.

In some examples, the imaging system 400 includes a 2D semantic map generator 470 that analyzes the 3D voxel representation 440 of the environment 415 using information from the input(s) 405 (e.g., the images 410 of the environment 415 from the perspectives 420) to generate 2D semantic maps 475 of the environment 415. The 2D semantic maps 475 of the environment 415 can categorize the objects depicted in the images 410 into different object categories (e.g., driveable surfaces, terrain, vegetation, structures, cars, trucks, people, non-vehicle paths, barriers, bicycles, buses, trains, construction vehicles, motorcycles, traffic cones, trailers, other flat surfaces, unobserved areas, general objects, and/or out-of-vocabulary object) while retaining the same perspectives 420 as the images 410. For instance, similarly to the 3D occupancy prediction map 345 and the 3D occupancy prediction map 455, in the 2D semantic maps 475, pixels colored in magenta (labeled “M”) represent driveable surfaces (e.g., asphalt), pixels colored in light green (labeled “g”) represent terrain (e.g., grass or dirt), pixels colored in dark green (labeled “G”) represent vegetation (e.g., trees, bushes), pixels colored in tan (labeled “T”) represent structures (e.g., buildings or other man-made structures), pixels colored in blue (labeled “B”) represent cars, pixels colored in purple (labeled “P”) represent trucks, pixels colored in red (labeled “R”) represent people (e.g., pedestrians), and pixels colored in brown (labeled “b”) represent non-vehicle paths (e.g., hiking trails, biking trails, sidewalks). In some examples, a different color scheme may be used, with different colors representing different categories of objects and/or occupancy states.

In some examples, the various functions of the imaging system 400 (e.g., the feature extraction 430, the feature averaging 435, the 3D prediction generator 450, the 2D depth map generator 460, and/or the 2D semantic map generator 470) can all be performed by portions of a ML model. For example, different functions of the imaging system 400 can be performed using different portions (e.g., layers, nodes, parameters, and/or weights) of the ML model. In some examples, the ML model can be trained in an end-to-end fashion using heterogeneous multi-task supervision. For instance, all three types of outputs (e.g., the 3D occupancy prediction map 455 of the environment 415, the 2D depth maps 465 of the environment 415, and the 2D semantic maps 475 of the environment 415) can be compared to ground truth of the environment 415. If an error or loss is detected in this comparison between any of the output(s) and the ground truth, such an error can be used to further train, tune, and/or otherwise update multiple portions of the ML model. Any such error or loss can be referred to as feedback (e.g., feedback 950), for instance being negative feedback (e.g., of the feedback 950).

In some examples, depth data from depth sensors can be used as ground truth for 3D voxel occupancy in the 3D voxel representations of the environment 415 (e.g., for the 3D voxel representation 440 and/or the 3D occupancy prediction map 455) and/or for the depths in the 2D depth maps 465. In some examples, depth data from depth sensors can be used as ground truth for 3D voxel occupancy in the 3D voxel representations of the environment 415 (e.g., for the 3D voxel representation 440 and/or the 3D occupancy prediction map 455) and/or for the depths in the 2D depth maps 465. In some examples, manually labeled semantic maps (e.g., 3D semantic maps or 2D semantic maps) of the environment 415 can be used as ground truth for the semantic mapping in the 3D occupancy prediction map 455 of the environment 415 and/or for the 2D semantic maps 475 of the environment 415.

In some examples, the supervised training can also provide positive feedback, for instance where the outputs (e.g., the 3D occupancy prediction map 455 of the environment 415, the 2D depth maps 465 of the environment 415, and the 2D semantic maps 475 of the environment 415) matches the ground truth (e.g., within a threshold margin of error) and/or compares favorably to the ground truth.

In an illustrative example, during training, the imaging system 400 can compare the depth data in the 2D depth maps 465 and the voxel positions in the 3D occupancy prediction map 455 to ground truth data for depth (e.g., from depth sensors). If the imaging system 400 finds error and/or loss (e.g., a difference in depth exceeding a threshold margin of error), the imaging system 400 can further train, tune, and/or update portions (e.g., layers, nodes, parameters, and/or weights) of the ML model corresponding to the feature extraction 430, the feature averaging 435, the 3D prediction generator 450, the 2D depth map generator 460, and/or the 2D semantic map generator 470 based on this negative feedback to discourage the erroneous outputs (e.g., the 2D depth maps 465 and/or the voxel positions in the 3D occupancy prediction map 455) given similar inputs, and to encourage outputs more similar to the ground truth given similar inputs, thereby improving accuracy for multiple functions of the ML model (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model based on the feedback can be performed using backpropagation based on the feedback.

On the other hand, if the imaging system 400 finds that the outputs (e.g., the 2D depth maps 465 and/or the voxel positions in the 3D occupancy prediction map 455) match the ground truth data for depth (e.g., from the depth sensors), the imaging system 400 can further train, tune, and/or update portions (e.g., layers, nodes, parameters, and/or weights) of the ML model corresponding to the feature extraction 430, the feature averaging 435, the 3D prediction generator 450, the 2D depth map generator 460, and/or the 2D semantic map generator 470 based on this positive feedback to encourage similar outputs given similar inputs, thereby improving accuracy for multiple functions of the ML model (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model based on the feedback can be performed using backpropagation based on the feedback.

In another illustrative example, during training, the imaging system 400 can compare the semantic data (e.g., labels, object categories) in the 2D semantic maps 475 and the semantic labels in the 3D occupancy prediction map 455 to ground truth data for semantic data (e.g., manually labeled image data with object categories). If the imaging system 400 finds error and/or loss (e.g., a difference in semantic labelling and/or object category exceeding a threshold margin of error), the imaging system 400 can further train, tune, and/or update portions (e.g., layers, nodes, parameters, and/or weights) of the ML model corresponding to the feature extraction 430, the feature averaging 435, the 3D prediction generator 450, the 2D depth map generator 460, and/or the 2D semantic map generator 470 based on this negative feedback to discourage the erroneous outputs (e.g., the 2D depth maps 465 and/or the voxel positions in the 3D occupancy prediction map 455) given similar inputs, and to encourage outputs more similar to the ground truth given similar inputs, thereby improving accuracy for multiple functions of the ML model (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model based on the feedback can be performed using backpropagation based on the feedback.

On the other hand, if the imaging system 400 finds that the outputs (e.g., the 2D semantic maps 475 and/or the semantic labels in the 3D occupancy prediction map 455) match the ground truth data for semantic data (e.g., manually labeled image data with object categories), the imaging system 400 can further train, tune, and/or update portions (e.g., layers, nodes, parameters, and/or weights) of the ML model corresponding to the feature extraction 430, the feature averaging 435, the 3D prediction generator 450, the 2D depth map generator 460, and/or the 2D semantic map generator 470 based on this positive feedback to encourage similar outputs given similar inputs, thereby improving accuracy for multiple functions of the ML model (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model based on the feedback can be performed using backpropagation based on the feedback.

In some examples, once the ML model is sufficiently trained, the imaging system 400 can remove or disable certain portions (e.g., layers, nodes, parameters, and/or weights) of the ML model, so that those portions of the ML model are removed or disabled during inference. For instance, in some examples, once the ML model is sufficiently trained, the imaging system 400 can remove or disable the 2D depth map generator 460 and/or the 2D semantic map generator 470, for instance to focus on the 3D prediction generator 450 during inference. In some examples, once the ML model is sufficiently trained, the imaging system 400 can remove or disable the 3D prediction generator 450 and/or the 2D depth map generator 460, for instance to focus on the 2D semantic map generator 470 during inference. In some examples, once the ML model is sufficiently trained, the imaging system 400 can remove or disable the 3D prediction generator 450 and/or the 2D semantic map generator 470, for instance to focus on the 2D depth map generator 460 during inference.

In some examples, the ML model(s) 335 of the imaging system 300 and/or the ML model(s) of the imaging system 400 can use attention (e.g., cross-view attention, cross-attention) to construct a 3D voxel representation (e.g., the 3D voxel representation 440) followed by 3D convolutions to process the 3D voxel representation for semantic prediction. However, such attention and 3D convolution operations can be computationally intensive, for instance utilizing a high amount of floating point operations per second (FLOPS). In some examples, the ML model(s) 335 of the imaging system 300 and/or the ML model(s) of the imaging system 400 can avoid attention (e.g., cross-view attention, cross-attention) for at least certain portions and/or functions of the ML model (e.g.,) to improve efficiency.

The process performed by the imaging system 400 can be referred to as Heterogeneous multi-task supervision to 3D Occupancy prediction (H3O). In some examples, the imaging system 400 can be referred to as an H3O system.

The imaging system 400 can perform an efficient method for 3D occupancy prediction that leverages heterogeneous multi-task supervision to significantly enhance accuracy and speed. The imaging system 400 integrates auxiliary tasks such as depth estimation (e.g., generation of the 2D depth maps 465 via the 2D depth map generator 460) and semantic segmentation (e.g., generation of the 2D semantic maps 475 via the 2D semantic map generator 470), which provide complementary information to enrich the primary task of 3D occupancy prediction (e.g., generation of the 3D occupancy prediction map 455 using the 3D prediction generator 450). By incorporating these auxiliary tasks, the ML model of the imaging system 400 learns richer and more discriminative features, leading to improved performance and accuracy. Built upon a deep learning framework, the ML model of the imaging system 400 effectively combines these tasks through a shared backbone network, addressing common issues such as occlusions and ambiguities in 3D space. The imaging system 400 performs an efficient 3D feature volume construction technique that avoids computationally expensive cross-attention mechanisms, instead utilizing depth-guided feature averaging to enhance efficiency.

The imaging system 400 leverages both 3D occupancy labels and semantic labels as well as 2D depth to train the ML model (e.g., occupancy network) of the imaging system 400, addressing the limitations of previous approaches. By projecting LiDAR points and segmentation labels onto each camera view, the imaging system 400 (or another system) forms 2D depth and semantic maps that can act as ground truth for additional supervision, particularly in regions where 3D occupancy labels are ambiguous.

The imaging system 400 uses an efficient 3D feature volume construction technique (e.g., to generate the 3D voxel representation 440) that avoids the computationally expensive cross-attention mechanisms. Instead, we utilize depth-guided feature averaging (e.g., feature averaging 435), where the imaging system 400 back-projects image features into 3D space based on rendered depth information. This allows the imaging system 400 to directly average features from multiple views to obtain voxel features at each 3D location, significantly enhancing the efficiency of the imaging system 400.

In some examples, the imaging system 400 maximizes the use of low-resolution images as input (e.g., as at least a subset of the images 410 in the input(s) 405) but also ensures robust learning in challenging regions, paving the way for more accurate and efficient 3D occupancy prediction (e.g., generation of the 3D occupancy prediction map 455). By integrating heterogeneous multi-task supervision, the imaging system 400 effectively combines the strengths of both 2D and 3D data, leading to a more comprehensive understanding of the environment 415.

The imaging system 400 addresses the computational inefficiencies of existing techniques. Traditional methods often require heavy cross-attention mechanisms to construct the 3D feature volume, which can be computationally prohibitive. In contrast, the depth-guided feature averaging approach (e.g., feature averaging 435) used by the imaging system 400 simplifies the generation of the 3D voxel representation 440 (and ultimately the generation of the 3D occupancy prediction map 455), making the imaging system 400 faster, more efficient, and more feasible for real-time applications. This efficiency gain does not come at the cost of accuracy; rather, the imaging system 400 also improves accuracy by enhancing the associated ML model's ability to learn from diverse data sources, resulting in improved performance in both well-defined and ambiguous regions.

The imaging system 400 represents a significant step forward in the field of 3D occupancy prediction. By leveraging 3D occupancy labels (e.g., associated with the 3D occupancy prediction map 455), 2D depth (e.g., associated with the 2D depth maps 465), and 2D semantic labels (e.g., associated with the 2D semantic maps 475), and by using an efficient method for 3D feature volume construction (e.g., feature averaging 435 to generate the 3D voxel representation 440), the imaging system 400 provides a robust and efficient solution that addresses the limitations of existing approaches.

Inferring 3D geometry of scenes from 2D images is a challenging task. The task of 3D occupancy prediction aims to produce a dense semantic voxel grid from multi-camera images capturing the surrounding environment. Given an ego-vehicle at time t, the system takes N camera images

$$I = {\{ {I}_{i} \}}_{i = 1}^{N}$$

(E.g., images) iv, images 410) as input (e.g., input(s) 305, input(s) 405) and predicts the 3D semantic occupancy volume O∈R^{H×H×W×Z×C}, where H, W, Z denotes the resolution of the volume and C is the number of classes. 3D occupancy prediction can be described using Equation 1:

$$O = G ( V ) , V = F ( I ) \qquad Equation 1$$

In Equation 1 above, F (⋅) is the image backbone that extracts multi-camera features (e.g., feature extraction 430) and transforms the features to 3D volume features V, and G(⋅) is another neural network that maps V into occupancy predictions. In some examples, G(⋅) can represent the feature averaging 435, the 3D prediction generator 450, or a combination thereof.

To obtain a 3D volume, the imaging system 400 generate the points corresponding to each voxel using Equation 2 below:

$$P = ( {f}_{x}^{- 1} ( {p}_{x} ) , {f}_{y}^{- 1} ( {p}_{y} ) , {f}_{z}^{- 1} ( {p}_{z} ) ) \qquad Equation 2$$

In Equation 2 above, f⁻¹ is the pixel uplifting operation. The imaging system 400 then projects the points back to each camera view and uses bilinear interpolation to get the 2D image features using Equation 3 below:

$${F}^{inter} = F 〈 π ( P , T , K ) 〉$$

In Equation 3 above, π(⋅) is the projection that maps the 3D point P to the image plane. T and K are the camera extrinsics and intrinsics, respectively. [symbol] ⋅ [symbol] is the bilinear interpolation operator and [⋅] is the index operator. F is the image feature and F^{inter} is the interpolated feature. Different from techniques that leverage heavy cross-attention to aggregate features, the imaging system 400 averages the multi-camera 2D features (e.g., via feature averaging 435) to obtain the voxel feature volume V (e.g., 3D voxel representation 440). In some examples, 3D convolutions (e.g., in the 3D prediction generator 450) are then used to process V (e.g., the 3D voxel representation 440) and generate the final occupancy predictions (e.g., the 3D occupancy prediction map 455).

Curating dense 3D occupancy ground-truth is a complicated and time-consuming process. Even with (semi)-automated pipelines, due to the complexity of the scenes (e.g., of the environment 415), there are areas that the 3D labels are ambiguous, distracting the learning of occupancy networks. The imaging system 400 imposes two auxiliary tasks, namely multi-camera depth estimation (e.g., generation of the 2D depth maps 465 using the 2D depth map generator 460) and semantic segmentation (e.g., generation of the 2D semantic maps 475 using the 2D semantic map generator 470) as shown FIG. 4, which helps enforce the multiview consistency of learned occupancy.

In some examples, the imaging system 400 adopts differentiable volume rendering. To render the depth of a pixel, a ray r from the camera center o is cast along the viewing direction d pointing to the pixel. Formally, r can be formulated according to Equation 4 below:

$$r ( t ) = o + td , t ∈ [ {t}_{s} , {t}_{e} ] . \qquad Equation 4$$

The imaging system 400 then samples M points

$${\{ {t}_{i} \}}_{i = 1}^{M}$$

following U[0, 1] along the ray to get the density σ(tᵢ). Then with the sampled M points, the imaging system 400 can obtain the depth of the corresponding pixel according to Equation 5 below:

$${D}^{p i x} = {\sum }_{i = 1}^{M} T ( i ) ( 1 - exp ( - σ ( {t}_{i} ) {δ}_{i} ) {t}_{i} \qquad Equation 5$$

In Equation 5 above,

$$T ( {t}_{i} ) = exp ( - {\sum }_{j = 1}^{i - 1} σ ( {t}_{i} ) {δ}_{i} )$$

and δᵢ=tᵢ+1−tᵢ are the intervals between the sampled points.

To render 2D semantic maps (e.g., the 2D semantic maps 475), an additional semantic head (e.g., the 2D semantic map generator 470) with C output channels is employed to map volume features V to semantic outputs S. The imaging system 400 then once again makes use of volume rendering to get-pixel semantic output according to Equation 6 below:

$${S}^{p i x} = {\sum }_{i = 1}^{{M}_{s}} T ( {t}_{i} ) ( 1 - exp ( - σ ( {t}_{i} ) ) {δ}_{i} ) S ( {t}_{i} ) \qquad Equation 6$$

In Equation 6 above, Mₛ=αM, α∈(0,1). The imaging system 400 project LiDAR points to each camera view to obtain 2D labels to supervise render depth (e.g., the 2D depth maps 465 and/or the voxel locations in the 3D occupancy prediction map 455) and semantic maps (e.g., the 2D semantic maps 475 and/or the semantic labels in the 3D occupancy prediction map 455).

For loss functions, the imaging system 400 can use cross-entropy loss to supervised 3D occupancy prediction O (e.g., 3D occupancy prediction map 455) and rendered 2D semantic maps S (e.g., 2D semantic maps 475). For rendered depth, the imaging system 400 can use the L1 loss. The imaging system 400 can use distortion loss to regularize the volume rendering weights. In some examples, the loss function is hence formulated as Equation 7 below:

$${L}_{total} = {L}_{s e m} ( O , \hat{O} ) + {λ}_{d} L ( D , \hat{D} ) + {λ}_{s e m} {L}_{s e m}^{2 d} ( S , \hat{S} ) + {λ}_{dist} {L}_{r e g} ( σ ) \qquad Equation 7$$

In Equation 7 above, Ô, \hat{D}, and Ŝ are the corresponding ground truth, and λ_{d}, λₛₑₘ, and λ_{dist} are the weights that balance the loss terms.

FIG. 5 is a block diagram illustrating examples of types of inputs 500 to an imaging system, such as images, 2D depth maps, 2D semantic maps, surface normal, local planar priors, and/or edge priors. For instance, in some examples, the input(s) 305 and/or the input(s) 405 can include any of the types of inputs 500 illustrated and/or discussed with respect to FIG. 5. The inputs 500 of FIG. 5 can be examples of input(s) 305, input(s) 405, input(s) 905, input(s) to an input layer 1010, input(s) from which features are extract in operation 1505, or some combination thereof.

The inputs 500 of FIG. 5 can include an image 505 of a scene 510 of a roadway with trees on either side, a 2D depth map 515 of the scene 510, a 2D semantic map 520 of the scene 510, or a combination thereof. For instance, similarly to the 2D semantic maps 475, in the 2D semantic map 520, pixels colored in magenta (labeled “M”) represent driveable surfaces (e.g., asphalt), pixels colored in light green (labeled “g”) represent terrain (e.g., grass or dirt), pixels colored in dark green (labeled “G”) represent vegetation (e.g., trees, bushes), pixels colored in tan (labeled “T”) represent structures (e.g., buildings or other man-made structures), pixels colored in blue (labeled “B”) represent cars, pixels colored in purple (labeled “P”) represent trucks, pixels colored in red (labeled “R”) represent people (e.g., pedestrians), and pixels colored in brown (labeled “b”) represent non-vehicle paths (e.g., hiking trails, biking trails, sidewalks). In some examples, a different color scheme may be used, with different colors representing different categories of objects and/or occupancy states.

The inputs 500 can include an image 525 of a scene 530 of a street in front of a building in an urban environment and/or a surface normal 535 of the scene 530. The inputs 500 can include an image 540 of a scene 545 of a street sign in front of vegetation and/or a local planar prior 550 of the scene 545. The street sign is circled with a dashed-line box in the local planar prior 550 of the scene 545. The inputs 500 can include an image 555 of a scene 560 of a suburban street with evenly spaced trees around it and/or an edge prior 565 of the scene 560.

In some examples, to obtain ground truth for depth, the imaging system 400 (or another system) projects depth sensor points captured using a depth sensor (e.g., LiDAR) and manually-applied segmentation labels to each camera view (e.g., to each of the perspectives 420) to form 2D depth and semantics ground truth data. Such 2D supervision (in addition to and/or instead of supervision using 3D occupancy labels) helps the ML model learn better in regions in which 3D occupancy labels are ambiguous, and/or where a greater level of detail (e.g., in curves or other shapes that aren't represented as well using voxels) is useful. The imaging system 400 can leverage more 2D geometric supervisions, such as: (a) 2D planes (e.g., as visible in the local planar prior 550), which are useful for flat surfaces like road, buildings and planar objects; (b) surface normal (e.g., surface normal 535), which are useful to regularize geometric prediction, and/or (c) 2D lines (e.g., edge prior 565), which are useful for capturing sharp changes like edges.

FIG. 6 is a conceptual diagram illustrating a technique 600 for 3D volume construction via feature averaging 435. In some examples, the imaging system 400 projects rays from 2D feature maps 605A-605D corresponding to the images 410, with each 2D feature map oriented relative to a 3D space associated with the voxel space based on the perspectives 420 of the images 410 (e.g., determined from camera intrinsics) to the features (extracted using the feature extraction 430) into the voxel space to identify locations of voxels (corresponding to specific features) in the voxel space to generate the 3D feature volume 610 of the environment (e.g., which may be an example of the 3D voxel representation 440 of the environment 415). In some examples, to perform feature averaging 435, the imaging system 400 uses bilinear interpolation to average feature locations corresponding to different perspectives 420 (e.g., for the same feature extracted from different images 410 of the environment 415, with the different 2D feature maps 605A-605D representing the different perspectives). In some examples, the imaging system 400 performs feature averaging 435 by directly averaging features from multiple perspectives 420 to obtain a voxel feature at each 3D location, without using any attention. In some examples, perspectives may be referred to as, and/or may be based on, poses and/or fields of view (FOV).

FIG. 7 is a birds-eye view diagram illustrating a vehicle 705 along with images 720A-720F captured using sensors 710A-710F coupled to the vehicle 705. Multiple sensors 710A-710F are coupled to the vehicle 705 at different positions along the vehicle 705. The sensors 710A-710F that capture images 720A-720F having different perspectives (e.g., the perspectives 320, the perspectives 420).

Referring to the imaging system 400, in some examples, high-resolution input images (e.g., for the images 410) can be useful to capture the fine details of the environment 415 to generate accurate outputs (e.g., to generate the 3D occupancy prediction map 455, the 2D depth maps 465, and/or the 2D semantic maps accurately), which also results in a heavy compute cost (e.g., in FLOPs) even with efficient image backbones. In some examples, a first subset of the images 410 can be input into the ML model of the imaging system 400 at a higher resolution, while a second subset of the images 410 can be input into the ML model of the imaging system 400 at a lower resolution.

In an illustrative example, images with similar perspectives can include redundant image data, and can thus be input into the ML model of the imaging system 400 at the lower resolution. Images with more unique perspectives can lack redundancy and can thus be input into the ML model of the imaging system 400 at the higher resolution to avoid missing important details.

Returning to FIG. 7, for instance, the sensors 710B-710C both face left (relative to the vehicle 705), and the images 720B-720C captured by the sensors 710B-710C depict some redundant portions of the environment around the vehicle 705. Similarly, the sensors 710D-710E both face right (relative to the vehicle 705), and the images 720D-720E captured by the sensors 710D-710E depict some redundant portions of the environment around the vehicle 705. Thus, the images 720B-720E can be input into the ML model of the imaging system 400 at the lower resolution. On the other hand, the sensor 710A faces forward (relative to the vehicle 705) and the sensor 710F faces backward (relative to the vehicle 705). The image 720A captured by the sensor 710A and image 720F captured by the sensor 710F include less redundant information. Thus, the image 720A and the image 720F can be input into the ML model of the imaging system 400 at the higher resolution.

In another illustrative example, images with more contextually-important perspectives can be input into the ML model of the imaging system 400 at the higher resolution, while images with less contextually-important perspectives can be input into the ML model of the imaging system 400 at the lower resolution.

For instance, the context that the images 720A-720F are to be used in is to help the vehicle 705 drive, for instance to help route the vehicle 705 (e.g., if the vehicle has self-driving or autonomous vehicle function(s)) and/or to help perform other automated driving assistance functions (e.g., automatic braking or swerving to avoid a collision in front, automatic accelerating or swerving to avoid a collision from behind, automatic braking or accelerating or swerving to avoid a collision from a side). In a driving context, forward-facing views (e.g., as in the image 720A captured by the sensor 710A) and/or rear-facing views (e.g., as in the image 720F captured by the sensor 710F) are more contextually-important, while side-facing views (e.g., as in the images 720B-720E captured by the sensors 710B-710E) are less contextually-important. Thus, the image 720A and the image 720F can be input into the ML model of the imaging system 400 at the higher resolution, and the images 720B-720E can be input into the ML model of the imaging system 400 at the lower resolution.

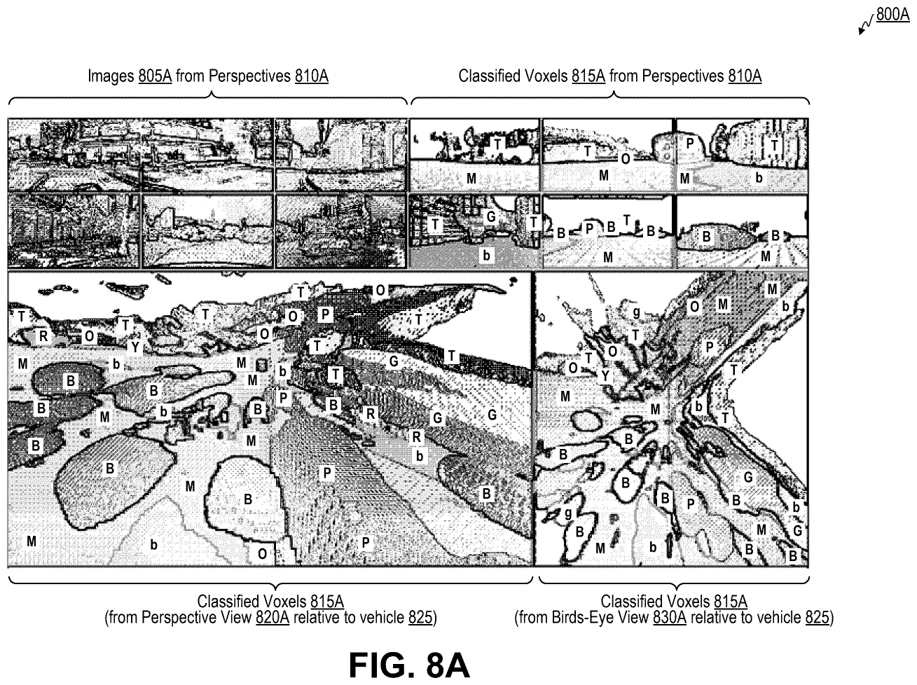

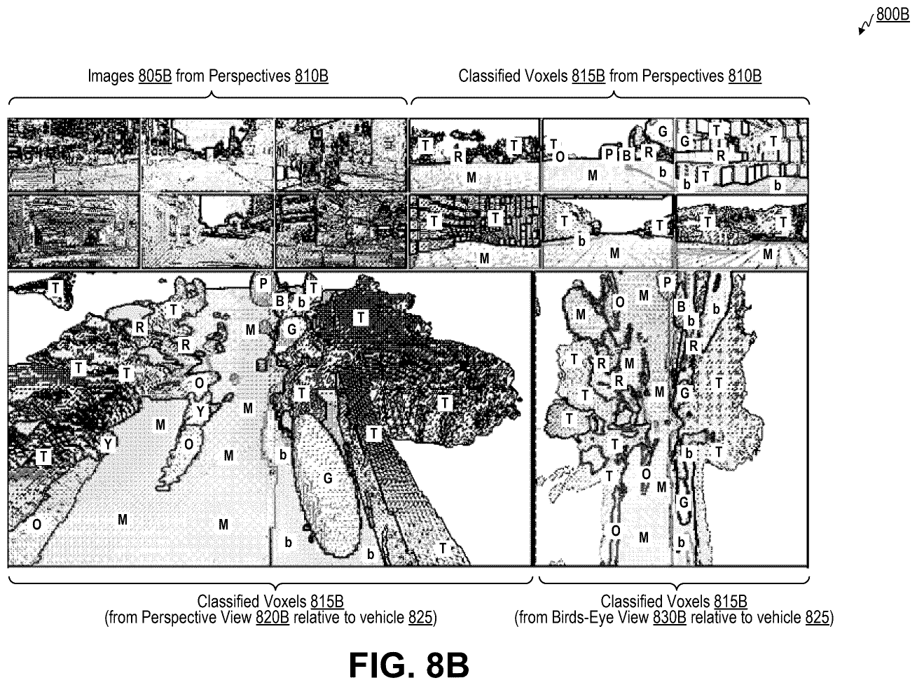

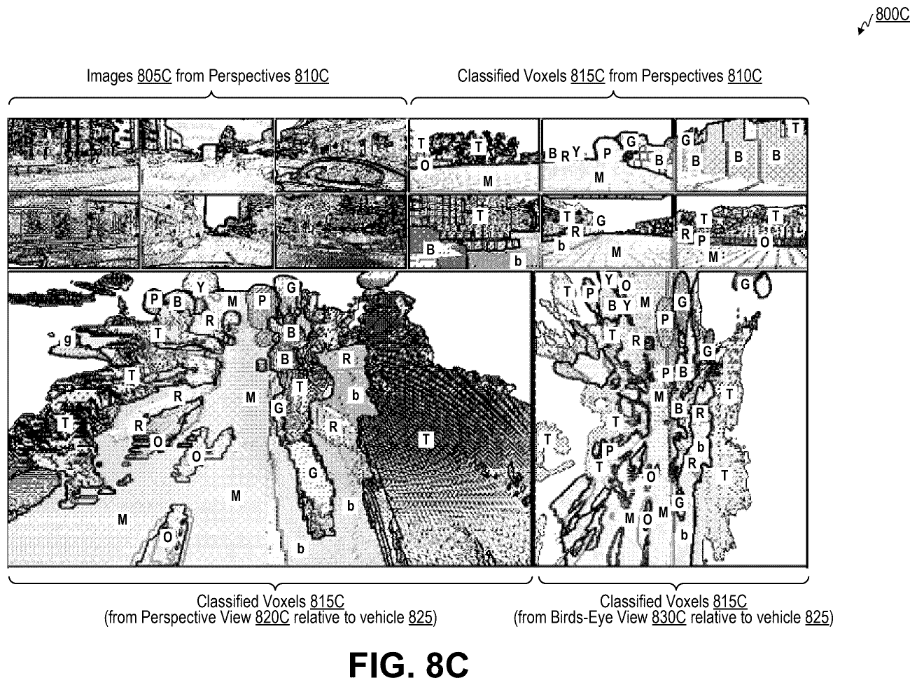

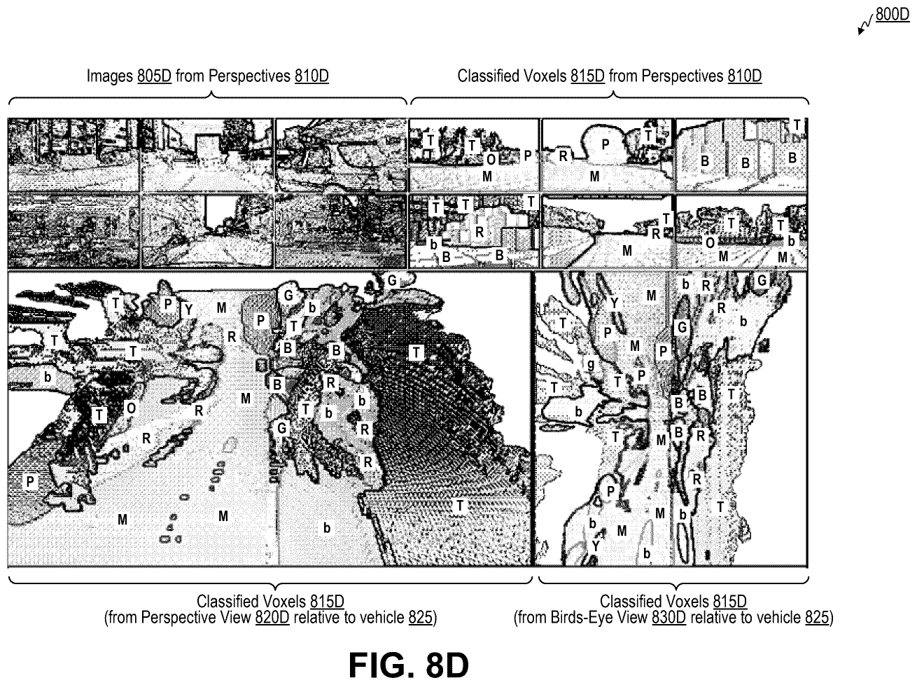

FIG. 8A is a conceptual diagram illustrating images 805A of an environment and classified voxels 815A representing the environment while a vehicle is in a first position in the environment. The images 805A are captured from various perspectives 810A relative to the vehicle, for instance being captured by six different cameras having different poses and being coupled to different portions of the vehicle (e.g., as in the sensors 710A-710F coupled to the vehicle 705). The classified voxels 815A are illustrated from the same various perspectives 810A as the images 805A. The classified voxels 815A are also illustrated from a perspective view 820A relative to the vehicle and from a birds-eye view 830A relative to the vehicles.

FIG. 8B is a conceptual diagram illustrating images 805B of the environment and classified voxels 815B representing the environment while the vehicle is in a second position in the environment. The images 805B are captured from various perspectives 810B relative to the vehicle, for instance being captured by six different cameras having different poses and being coupled to different portions of the vehicle. The classified voxels 815B are illustrated from the same various perspectives 810B as the images 805B. The classified voxels 815B are also illustrated from a perspective view 820B relative to the vehicle and from a birds-eye view 830B relative to the vehicle.

FIG. 8C is a conceptual diagram illustrating images 805C of the environment and classified voxels 815C representing the environment while the vehicle is in a third position in the environment. The images 805C are captured from various perspectives 810C relative to the vehicle, for instance being captured by six different cameras having different poses and being coupled to different portions of the vehicle. The classified voxels 815C are illustrated from the same various perspectives 810C as the images 805C. The classified voxels 815C are also illustrated from a perspective view 820C relative to the vehicle and from a birds-eye view 830C relative to the vehicle.

FIG. 8D is a conceptual diagram illustrating images 805D of the environment and classified voxels 815D representing the environment while the vehicle is in a fourth position in the environment. The images 805D are captured from various perspectives 810D relative to the vehicle, for instance being captured by six different cameras having different poses and being coupled to different portions of the vehicle. The classified voxels 815D are illustrated from the same various perspectives 810D as the images 805D. The classified voxels 815D are also illustrated from a perspective view 820D relative to the vehicle and from a birds-eye view 830D relative to the vehicle.

In the 815A-815D of FIGS. 8A-8D, voxels colored in magenta (labeled “M”) represent driveable surfaces (e.g., asphalt), voxels colored in light green (labeled “g”) represent terrain (e.g., grass or dirt), voxels colored in dark green (labeled “G”) represent vegetation (e.g., trees, bushes), voxels colored in tan (labeled “T”) represent structures (e.g., buildings or other man-made structures), voxels colored in blue (labeled “B”) represent cars, voxels colored in purple (labeled “P”) represent trucks, voxels colored in orange (labeled “O”) represent barriers, voxels colored in red (labeled “R”) represent people (e.g., pedestrians), voxels colored in cyan (labeled “C”) represent glass, and voxels colored in brown (labeled “b”) represent non-vehicle paths (e.g., hiking trails, biking trails, sidewalks).

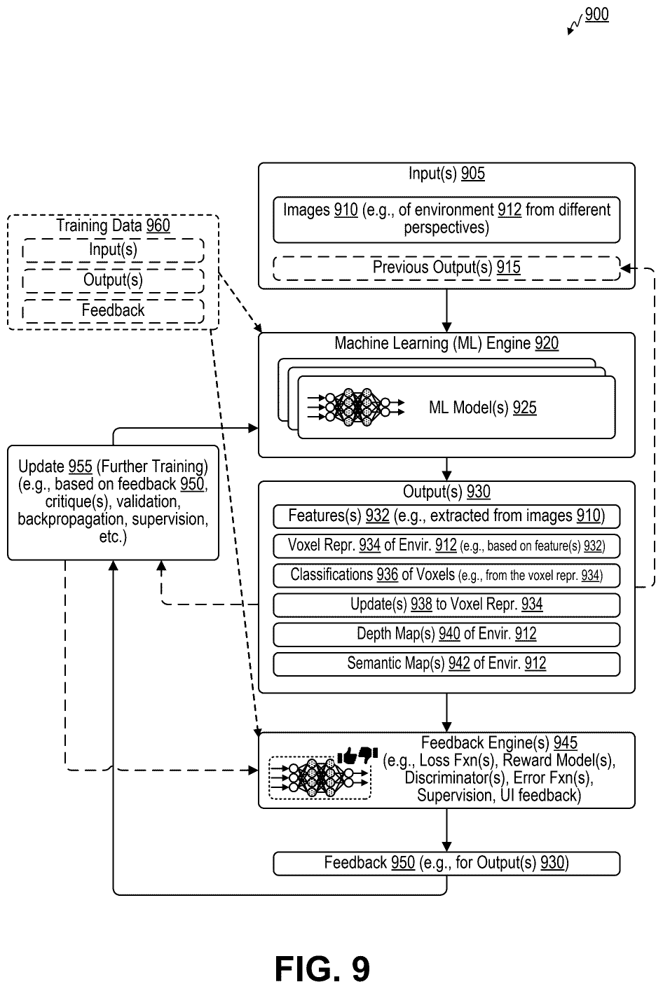

FIG. 9 is a block diagram illustrating a machine learning system for training, use (e.g., inference), and updating (e.g., further training) of machine learning (ML) model(s) associated with an ML prediction engine for processing images of an environment to extract features, to generate a voxel representation of the environment, to determine classifications of the voxels in the voxel representation, to generate updates to the voxel representation, to generate depth map(s) of the environment, and/or to generate semantic map(s) of the environment. Within FIG. 9, a graphic representing the ML model(s) 925 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 925 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 925 can include a feed-forward network, in which case there are no feedback connections where outputs of the network are fed back into itself. In some cases, the ML model(s) 925 can include a recurrent neural network, which can have loops that allow information to be carried across nodes while reading in input. In some cases, the network can include a convolutional neural network, which may not link every node in one layer to every other node in the next layer.

One or more input(s) 905 can be provided to the ML model(s) 925. The ML model(s) 925 can be trained by the ML engine 920 (e.g., based on training data 960) to generate one or more output(s) 930. In some examples, the input(s) 905 include images 910 of an environment 912 from different perspectives (e.g., images captured using the image capture and processing system 100, the image 210, the image 220, the images 310 of the environment 315 from the perspectives 320, the images 410 of the environment 415 from the perspectives 420, the inputs 500, the images 720A-720F, the images 805A-805D from the perspectives 810A-810D, or a combination thereof. In some examples, the input(s) 905 can include other types of inputs, such as other input types of the input(s) 305, other input types of the input(s) 405, other input types of the inputs 500, depth maps (e.g., 2D depth map 515), semantic maps (e.g., 2D semantic map 520), surface normals (e.g., surface normal 535), local planar priors (e.g., local planar prior 550), edge priors (e.g., edge prior 565), depth data such as point clouds, and/or other types of inputs discussed herein.

The output(s) 930 generated by the ML model(s) 925 in response to input of the input(s) 905 (e.g., in response to the images 910 and/or previous output(s) 915) into the ML model(s) 925 can include feature(s) 932 extracted from the images 910 (e.g., via feature extraction 430), a voxel representation 934 of the environment 912 (based on the feature(s) 932, for instance generated via feature averaging 435), classification(s) 936 (e.g., of occupancy state and/or semantic label) of voxels in the voxel representation 934 of the environment 912 (e.g., for the 3D occupancy prediction map 455 by the 3D prediction generator 450), update(s) 938 to the voxel representation 934 of the environment 912, depth map(s) 940 of the environment 912 (e.g., the 2D depth maps 465 generated using the 2D depth map generator 460), and/or semantic map(s) 942 of the environment 912 (e.g., the 2D semantic maps 475 generated using the 2D semantic map generator 470).

In some examples, the input(s) 905 can include previous output(s) 915, such as feature(s) 932, the voxel representation 934, the classification(s) 936 of voxels, the update(s) 938 to the voxel representation 934, the depth map(s) 940, the semantic map(s) 942, and/or other types of output(s) 930 previously generated (e.g., in previous passes or layers) by the ML model(s) 925. In some examples, the input(s) 905 can include partially-processed data that is to be processed further, such as various features, weights, intermediate data, layer data from specific layer(s) of the ML model(s) 925, or a combinations thereof. In some examples, the previous output(s) 915 are used as input(s) 905 for specific portions (e.g., layers, nodes) of the ML model(s) 925.

In some examples, the ML system 900 (that includes the ML engine 920 and/or ML model(s) 925) adds the output(s) 930 to a data store(s), such as data structure(s) associated with one of the imaging systems described herein. Data (e.g., the previous output(s) 915) can be drawn from these data store(s) to use as input(s) 905 for the ML model(s) 925 for generating future output(s) 930.

In some examples, the ML system repeats the process illustrated in FIG. 9 multiple times to generate the output(s) 930 in multiple passes, using some of the output(s) 930 from earlier passes as some of the input(s) 905 in later passes. For instance, in an illustrative example, in a first pass, the ML model(s) 925 can process the images 910 to extract feature(s) 932 from the images 910 (e.g., via feature extraction 430). In a second pass, the ML model(s) 925 can process the feature(s) 932 (e.g., from the first pass as previous output(s) 915) to generate the voxel representation 934 of the environment 912 (e.g., via feature averaging 435). In a third pass, the ML model(s) 925 can process the voxel representation 934 of the environment 912 (e.g., from the second pass as previous output(s) 915), feature(s) 932 (e.g., from the first pass as previous output(s) 915), and/or the images 910 to identify classification(s) 936 (e.g., of occupancy state and/or semantic label) of voxels in the voxel representation 934 of the environment 912 and/or to identify update(s) 938 to the voxel representation 934 of the environment 912 to generate a 3D occupancy prediction map (e.g., 3D occupancy prediction map 455). In some examples, in the third pass or a fourth pass, the ML model(s) 925 can process the voxel representation 934 of the environment 912 (e.g., from the second pass as previous output(s) 915), feature(s) 932 (e.g., from the first pass as previous output(s) 915), and/or the images 910 to generate the depth map(s) 940 of the environment 912 (e.g., the 2D depth maps 465 generated using the 2D depth map generator 460) and/or the semantic map(s) 942 of the environment 912 (e.g., the 2D semantic maps 475 generated using the 2D semantic map generator 470).

In some examples, the ML system includes one or more feedback engine(s) 945 that generate and/or provide feedback 950 about the output(s) 930. In some examples, the feedback 950 indicates how well the output(s) 930 align to corresponding expected output(s), how well the output(s) 930 serve their intended purpose, how accurate the output(s) 930 are in comparison to later context (e.g., how accurate the predictive simulation(s) 935 of upgrading the instrument end up being compared to the actual results of upgrading the instrument), or a combination thereof. In some examples, the feedback engine(s) 945 include loss function(s), reward model(s) (e.g., other ML model(s) that are used to score the output(s) 930), discriminator(s), error function(s) (e.g., in back-propagation), user interface feedback received via a user interface from a user, supervision-based comparisons to ground truth, or a combination thereof. In some examples, the feedback 950 can include one or more alignment score(s) that score a level of alignment between the output(s) 930 and the expected output(s) and/or intended purpose.

The ML engine 920 of the ML system can update (further train) the ML model(s) 925 based on the feedback 950 to perform an update 955 (e.g., further training) of the ML model(s) 925 based on the feedback 950. In some examples, the feedback 950 includes positive feedback, for instance indicating that the output(s) 930 closely align with expected output(s) and/or that the output(s) 930 serve their intended purpose. In some examples, the feedback 950 includes negative feedback, for instance indicating a mismatch between the output(s) 930 and the expected output(s), and/or that the output(s) 930 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback. In response to positive feedback in the feedback 950, the ML engine 920 can perform the update 955 to update the ML model(s) 925 to strengthen and/or reinforce weights associated with generation of the output(s) 930 to encourage the ML engine 920 to generate similar output(s) 930 given similar input(s) 905. In response to negative feedback in the feedback 950, the ML engine 920 can perform the update 955 to update the ML model(s) 925 to weaken and/or remove weights associated with generation of the output(s) 930 to discourage the ML engine 920 from generating similar output(s) 930 given similar input(s) 905.

In an illustrative example, the ML system 900 can compare the depth data in the 2D depth maps 465 and the voxel positions in the 3D occupancy prediction map 455 to ground truth data for depth (e.g., from depth sensors). If the ML system 900 finds error and/or loss (e.g., a difference in depth exceeding a threshold margin of error), the ML system 900 can further train, tune, and/or update portions (e.g., layers, nodes, parameters, and/or weights) of the ML model(s) 925 corresponding to the feature extraction 430, the feature averaging 435, the 3D prediction generator 450, the 2D depth map generator 460, and/or the 2D semantic map generator 470 based on this negative feedback 950 to discourage the erroneous outputs (e.g., the 2D depth maps 465 and/or the voxel positions in the 3D occupancy prediction map 455) given similar inputs, and to encourage outputs more similar to the ground truth given similar inputs, thereby improving accuracy for multiple functions of the ML model(s) 925 (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model(s) 925 based on the feedback 950 can be performed using backpropagation based on the feedback 950.

On the other hand, if the ML system 900 finds that the outputs (e.g., the 2D depth maps 465 and/or the voxel positions in the 3D occupancy prediction map 455) match the ground truth data for depth (e.g., from the depth sensors), the ML system 900 can further train, tune, and/or update portions (e.g., layers, nodes, parameters, and/or weights) of the ML model(s) 925 corresponding to the feature extraction 430, the feature averaging 435, the 3D prediction generator 450, the 2D depth map generator 460, and/or the 2D semantic map generator 470 based on this positive feedback 950 to encourage similar outputs given similar inputs, thereby improving accuracy for multiple functions of the ML model(s) 925 (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model(s) 925 based on the feedback 950 can be performed using backpropagation based on the feedback 950.

In another illustrative example, during training, the ML system 900 can compare the semantic data (e.g., labels, object categories) in the 2D semantic maps 475 and the semantic labels in the 3D occupancy prediction map 455 to ground truth data for semantic data (e.g., manually labeled image data with object categories). If the ML system 900 finds error and/or loss (e.g., a difference in semantic labelling and/or object category exceeding a threshold margin of error), the ML system 900 can further train, tune, and/or update portions (e.g., layers, nodes, parameters, and/or weights) of the ML model(s) 925 corresponding to the feature extraction 430, the feature averaging 435, the 3D prediction generator 450, the 2D depth map generator 460, and/or the 2D semantic map generator 470 based on this negative feedback 950 to discourage the erroneous outputs (e.g., the 2D depth maps 465 and/or the voxel positions in the 3D occupancy prediction map 455) given similar inputs, and to encourage outputs more similar to the ground truth given similar inputs, thereby improving accuracy for multiple functions of the ML model(s) 925 (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model(s) 925 based on the feedback 950 can be performed using backpropagation based on the feedback 950.

On the other hand, if the ML system 900 finds that the outputs (e.g., the 2D semantic maps 475 and/or the semantic labels in the 3D occupancy prediction map 455) match the ground truth data for semantic data (e.g., manually labeled image data with object categories), the ML system 900 can further train, tune, and/or update portions (e.g., layers, nodes, parameters, and/or weights) of the ML model(s) 925 corresponding to the feature extraction 430, the feature averaging 435, the 3D prediction generator 450, the 2D depth map generator 460, and/or the 2D semantic map generator 470 based on this positive feedback 950 to encourage similar outputs given similar inputs, thereby improving accuracy for multiple functions of the ML model(s) 925 (e.g., the feature extraction 430, the feature averaging 435, the 3D prediction generator 450, the 2D depth map generator 460, and/or the 2D semantic map generator 470). In some examples, the further training, tuning, and/or updating of the portions of the ML model(s) 925 based on the feedback 950 can be performed using backpropagation based on the feedback 950.

In some examples, the ML engine 920 can also perform an initial training of the ML model(s) 925 before the ML model(s) 925 are used to generate the output(s) 930 based on the input(s) 905. During the initial training, the ML engine 920 can train the ML model(s) 925 based on training data 960. In some examples, the training data 960 includes examples of input(s) (of any input types discussed with respect to the input(s) 905), output(s) (of any output types discussed with respect to the output(s) 930), and/or feedback (of any feedback types discussed with respect to the feedback 950). In some cases, positive feedback in the training data 960 can be used to perform positive training, to encourage the ML model(s) 925 to generate output(s) similar to the output(s) in the training data given input of the corresponding input(s) in the training data. In some cases, negative feedback in the training data 960 can be used to perform negative training, to discourage the ML model(s) 925 from generate output(s) similar to the output(s) in the training data given input of the corresponding input(s) in the training data. In some examples, the initial training (using the training data 960) can be performed over multiple stages or rounds, for instance including a training stage, a validation stage, and/or a testing stage. The initial training (using the training data 960) can improve the accuracy of the output(s) 930 (e.g., the predictive simulation(s) 935) generated by the ML model(s) 925.

In some examples, the ML model(s) 925 can generate and/or update the output(s) 930 (e.g., the predictive simulation(s) 935) dynamically and in real-time as the input(s) 905 (e.g., the images 910 about the dataset and/or the request and/or the previous output(s) 915) continue to be received by the ML model(s) 925. This can ensure that the output(s) 930 (e.g., the predictive simulation(s) 935) are generated based on up-to-date input(s) 905 (e.g., up-to-date images 910). For instance, if the images 910 includes data from a data stream that continues to be received over time, the ML model(s) 925 can continue to update the output(s) 930 (e.g., the predictive simulation(s) 935) dynamically and in real-time as the input(s) 905 (e.g., the images 910) continue to be received.

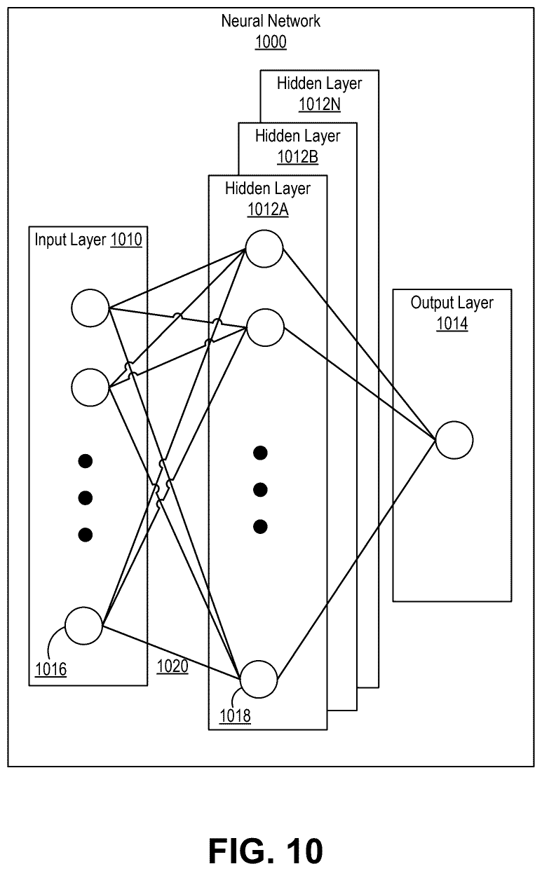

FIG. 10 is a block diagram illustrating an example of a neural network 1000 that can be used for imaging operations. The neural network 1000 can include any type of deep network, such as a convolutional neural network (CNN), an autoencoder, a deep belief net (DBN), a Recurrent Neural Network (RNN), a Generative Adversarial Networks (GAN), an auto-regressive transformer models, and/or other type of neural network. The neural network 1000 may be, and/or may include, an example of the model(s) 335, ML model(s) of imaging system 400, the ML model(s) 925, or a combination thereof.

An input layer 1010 of the neural network 1000 includes input data. The input data of the input layer 1010 can include images captured using the image capture and processing system 100, the image 210, the image 220, the images 310 of the environment 315 from the perspectives 320, the images 410 of the environment 415 from the perspectives 420, the inputs 500, the images 720A-720F, the images 805A-805D from the perspectives 810A-810D, the input(s) 905, images 910 of an environment 912 from different perspectives, previous output(s) 915, other images, depth maps (e.g., 2D depth map 515), semantic maps (e.g., 2D semantic map 520), surface normals (e.g., surface normal 535), local planar priors (e.g., local planar prior 550), edge priors (e.g., edge prior 565), depth data such as point clouds, other types of inputs discussed herein, or a combination thereof.

The neural network 1000 includes multiple hidden layers 1012, 1012B, through 1012N. The hidden layers 1012, 1012B, through 1012N include “N” number of hidden layers, where “N” is an integer greater than or equal to one. The number of hidden layers can be made to include as many layers as needed for the given application. The neural network 1000 further includes an output layer 1014 that provides an output resulting from the processing performed by the hidden layers 1012, 1012B, through 1012N.

In some examples, the output layer 1014 can provide output data. The output data can include the output(s) 340, the 3D occupancy prediction map 345, the features extracted via the feature extraction 430, the 3D voxel representation 440, the 3D occupancy prediction map 455, the 2D depth maps 465, the 2D semantic maps 475, the output(s) 930, the feature(s) 932 extracted from the images 910 (e.g., via feature extraction 430), the voxel representation 934 of the environment 912 (based on the feature(s) 932, for instance generated via feature averaging 435), classification(s) 936 (e.g., of occupancy state and/or semantic label) of voxels in the voxel representation 934 of the environment 912 (e.g., for the 3D occupancy prediction map 455 by the 3D prediction generator 450), the update(s) 938 to the voxel representation 934 of the environment 912, the depth map(s) 940 of the environment 912 (e.g., the 2D depth maps 465 generated using the 2D depth map generator 460), the semantic map(s) 942 of the environment 912 (e.g., the 2D semantic maps 475 generated using the 2D semantic map generator 470), other types of outputs discussed herein, or a combination thereof.

The neural network 1000 is a multi-layer neural network of interconnected filters. Each filter can be trained to learn a feature representative of the input data. Information associated with the filters is shared among the different layers and each layer retains information as information is processed. In some cases, the neural network 1000 can include a feed-forward network, in which case there are no feedback connections where outputs of the network are fed back into itself. In some cases, the network 1000 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 1010 can activate a set of nodes in the first hidden layer 1012A. For example, as shown, each of the input nodes of the input layer 1010 can be connected to each of the nodes of the first hidden layer 1012A. The nodes of a hidden layer can transform the information of each input node by applying activation functions (e.g., filters) to this information. The information derived from the transformation can then be passed to and can activate the nodes of the next hidden layer 1012B, which can perform their own designated functions. Example functions include convolutional functions, downscaling, upscaling, data transformation, and/or any other suitable functions. The output of the hidden layer 1012B can then activate nodes of the next hidden layer, and so on. The output of the last hidden layer 1012N can activate one or more nodes of the output layer 1014, which provides a processed output image. In some cases, while nodes (e.g., node 1016) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

In some aspects, training of one or more of the machine learning systems or neural networks described herein can be performed using online training (e.g., in some case on-device training), offline training, and/or various combinations of online and offline training. In some cases, online may refer to time periods during which the input data (e.g., such as the input data discussed with respect to the input layer 1010) is processed, for instance for generating output data (e.g., such as the input data discussed with respect to the output layer 1014). In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

The neural network 1000 is pre-trained to process the features from the data in the input layer 1010 using the different hidden layers 1012, 1012B, through 1012N in order to provide the output through the output layer 1014.

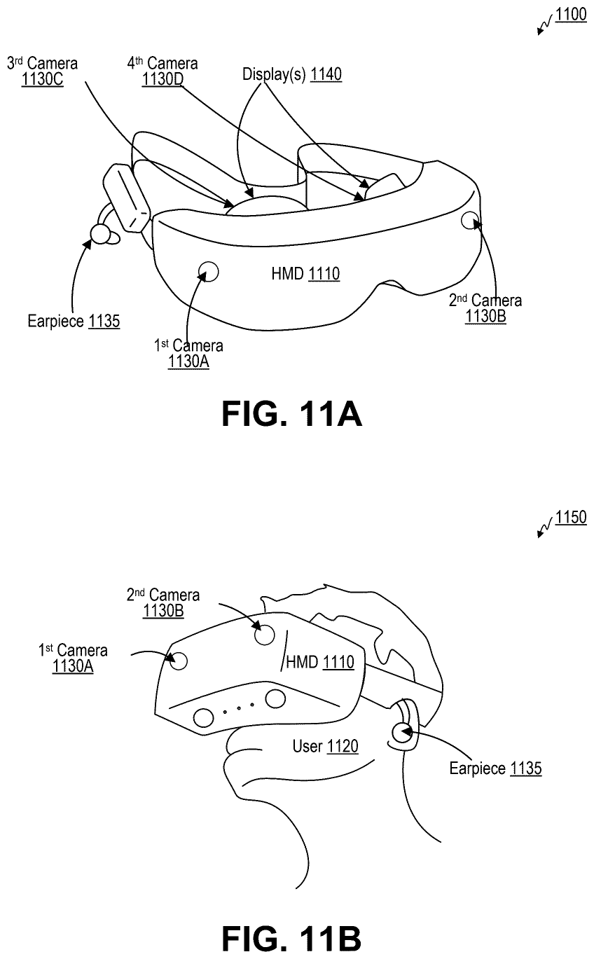

FIG. 11A is a perspective diagram 1100 illustrating a head-mounted display (HMD) 1110 that is used as part of an imaging system (e.g., imaging system 300, imaging system 400). The HMD 1110 may be, for example, an augmented reality (AR) headset, a virtual reality (VR) headset, a mixed reality (MR) headset, an extended reality (XR) headset, or some combination thereof. The HMD 1110 includes a first camera 1130A and a second camera 1130B along a front portion of the HMD 1110. The HMD 1110 includes a third camera 1130C and a fourth camera 1130D facing the eye(s) of the user as the eye(s) of the user face the display(s) 1140. In some examples, the HMD 1110 may only have a single camera with a single image sensor. In some examples, the HMD 1110 may include one or more additional cameras in addition to the first camera 1130A, the second camera 1130B, third camera 1130C, and the fourth camera 1130D. In some examples, the HMD 1110 may include one or more additional sensors in addition to the first camera 1130A, the second camera 1130B, third camera 1130C, and the fourth camera 1130D. In some examples, the first camera 1130A, the second camera 1130B, third camera 1130C, and/or the fourth camera 1130D may be examples of the image capture and processing system 100, the image capture device 105A, the image processing device 105B, another camera or sensor discussed herein, or a combination thereof.

The HMD 1110 may include one or more displays 1140 that are visible to a user 1120 wearing the HMD 1110 on the user 1120's head. In some examples, the HMD 1110 may include one display 1140 and two viewfinders. The two viewfinders can include a left viewfinder for the user 1120's left eye and a right viewfinder for the user 1120's right eye. The left viewfinder can be oriented so that the left eye of the user 1120 sees a left side of the display. The right viewfinder can be oriented so that the right eye of the user 1120 sees a right side of the display. In some examples, the HMD 1110 may include two displays 1140, including a left display that displays content to the user 1120's left eye and a right display that displays content to a user 1120's right eye. The one or more displays 1140 of the HMD 1110 can be digital “pass-through” displays or optical “see-through” displays.

The HMD 1110 may include one or more earpieces 1135, which may function as speakers and/or headphones that output audio to one or more ears of a user of the HMD 1110. One earpiece 1135 is illustrated in FIGS. 11A and 11B, but it should be understood that the HMD 1110 can include two earpieces, with one earpiece for each ear (left ear and right ear) of the user. In some examples, the HMD 1110 can also include one or more microphones (not pictured). In some examples, the audio output by the HMD 1110 to the user through the one or more earpieces 1135 may include, or be based on, audio recorded using the one or more microphones.

FIG. 11B is a perspective diagram 1150 illustrating the head-mounted display (HMD) of FIG. 11A being worn by a user 1120. The user 1120 wears the HMD 1110 on the user 1120's head over the user 1120's eyes. The HMD 1110 can capture images with the first camera 1130A and the second camera 1130B. In some examples, the HMD 1110 displays one or more output images toward the user 1120's eyes using the display(s) 1140. In some examples, the output images can include processed image data (e.g., a 3D occupancy prediction map such as the 3D occupancy prediction map 455). The output images can be based on the images captured by the first camera 1130A and the second camera 1130B (e.g., the image sensor 130), for example with the processed image data (e.g., a 3D occupancy prediction map such as the 3D occupancy prediction map 455) overlaid. The output images may provide a stereoscopic view of the environment, in some cases with the processed content overlaid and/or with other modifications. For example, the HMD 1110 can display a first display image to the user 1120's right eye, the first display image based on an image captured by the first camera 1130A. The HMD 1110 can display a second display image to the user 1120's left eye, the second display image based on an image captured by the second camera 1130B. For instance, the HMD 1110 may provide overlaid processed content in the display images overlaid over the images captured by the first camera 1130A and the second camera 1130B. The third camera 1130C and the fourth camera 1130D can capture images of the eyes of the before, during, and/or after the user views the display images displayed by the display(s) 1140. This way, the sensor data from the third camera 1130C and/or the fourth camera 1130D can capture reactions to the processed content by the user's eyes (and/or other portions of the user). An earpiece 1135 of the HMD 1110 is illustrated in an ear of the user 1120. The HMD 1110 may be outputting audio to the user 1120 through the earpiece 1135 and/or through another earpiece (not pictured) of the HMD 1110 that is in the other ear (not pictured) of the user 1120.

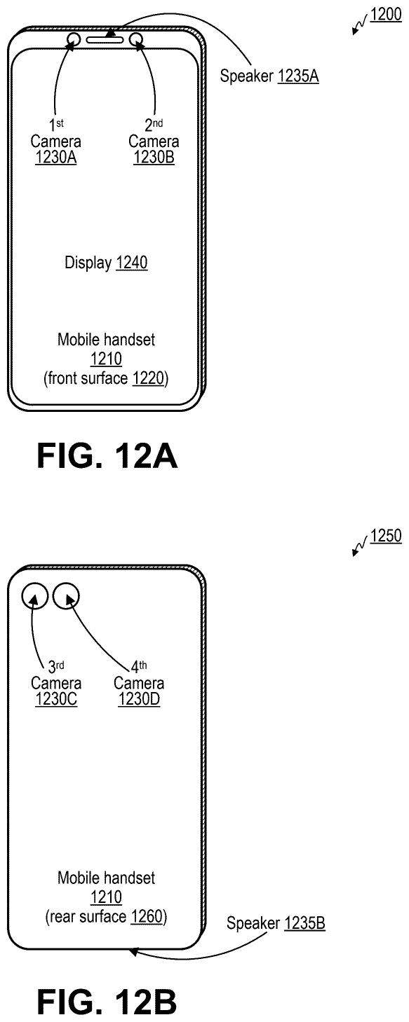

FIG. 12A is a perspective diagram 1200 illustrating a front surface of a mobile handset 1210 that includes front-facing cameras and can be used as part of an imaging system (e.g., imaging system 300, imaging system 400). The mobile handset 1210 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 1220 of the mobile handset 1210 includes a display 1240. The front surface 1220 of the mobile handset 1210 includes a first camera 1230A and a second camera 1230B. The first camera 1230A and the second camera 1230B can face the user, including the eye(s) of the user, while processed image data (e.g., a 3D occupancy prediction map such as the 3D occupancy prediction map 455) is displayed on the display 1240.

The first camera 1230A and the second camera 1230B are illustrated in a bezel around the display 1240 on the front surface 1220 of the mobile handset 1210. In some examples, the first camera 1230A and the second camera 1230B can be positioned in a notch or cutout that is cut out from the display 1240 on the front surface 1220 of the mobile handset 1210. In some examples, the first camera 1230A and the second camera 1230B can be under-display cameras that are positioned between the display 1240 and the rest of the mobile handset 1210, so that light passes through a portion of the display 1240 before reaching the first camera 1230A and the second camera 1230B. The first camera 1230A and the second camera 1230B of the perspective diagram 1200 are front-facing cameras. The first camera 1230A and the second camera 1230B face a direction perpendicular to a planar surface of the front surface 1220 of the mobile handset 1210. The first camera 1230A and the second camera 1230B may be two of the one or more cameras of the mobile handset 1210. In some examples, the front surface 1220 of the mobile handset 1210 may only have a single camera.

In some examples, the display 1240 of the mobile handset 1210 displays one or more output images toward the user using the mobile handset 1210. In some examples, the output images can include the processed image data (e.g., a 3D occupancy prediction map such as the 3D occupancy prediction map 455). The output images can be based on the images (e.g., captured by image sensor 130) captured by the first camera 1230A, the second camera 1230B, the third camera 1230C, and/or the fourth camera 1230D, for example with the processed image data (e.g., a 3D occupancy prediction map such as the 3D occupancy prediction map 455) overlaid.

In some examples, the front surface 1220 of the mobile handset 1210 may include one or more additional cameras in addition to the first camera 1230A and the second camera 1230B. In some examples, the front surface 1220 of the mobile handset 1210 may include one or more additional sensors in addition to the first camera 1230A and the second camera 1230B. In some cases, the front surface 1220 of the mobile handset 1210 includes more than one display 1240. For example, the one or more displays 1240 can include one or more touchscreen displays.

The mobile handset 1210 may include one or more speakers 1235A and/or other audio output devices (e.g., earphones or headphones or connectors thereto), which can output audio to one or more ears of a user of the mobile handset 1210. One speaker 1235A is illustrated in FIG. 12A, but it should be understood that the mobile handset 1210 can include more than one speaker and/or other audio device. In some examples, the mobile handset 1210 can also include one or more microphones (not pictured). In some examples, the audio output by the mobile handset 1210 to the user through the one or more speakers 1235A and/or other audio output devices may include, or be based on, audio recorded using the one or more microphones.

FIG. 12B is a perspective diagram 1250 illustrating a rear surface 1260 of a mobile handset that includes rear-facing cameras and that can be used as part of a sensor data processing system. The mobile handset 1210 includes a third camera 1230C and a fourth camera 1230D on the rear surface 1260 of the mobile handset 1210. The third camera 1230C and the fourth camera 1230D of the perspective diagram 1250 are rear-facing. The third camera 1230C and the fourth camera 1230D face a direction perpendicular to a planar surface of the rear surface 1260 of the mobile handset 1210.

The third camera 1230C and the fourth camera 1230D may be two of the one or more cameras of the mobile handset 1210. In some examples, the rear surface 1260 of the mobile handset 1210 may only have a single camera. In some examples, the rear surface 1260 of the mobile handset 1210 may include one or more additional cameras in addition to the third camera 1230C and the fourth camera 1230D. In some examples, the rear surface 1260 of the mobile handset 1210 may include one or more additional sensors in addition to the third camera 1230C and the fourth camera 1230D. In some examples, the first camera 1230A, the second camera 1230B, third camera 1230C, and/or the fourth camera 1230D may be examples of the image capture and processing system 100, the image capture device 105A, the image processing device 105B, another camera or sensor discussed herein, or a combination thereof.

The mobile handset 1210 may include one or more speakers 1235B and/or other audio output devices (e.g., earphones or headphones or connectors thereto), which can output audio to one or more ears of a user of the mobile handset 1210. One speaker 1235B is illustrated in FIG. 12B, but it should be understood that the mobile handset 1210 can include more than one speaker and/or other audio device. In some examples, the mobile handset 1210 can also include one or more microphones (not pictured). In some examples, the mobile handset 1210 can include one or more microphones along and/or adjacent to the rear surface 1260 of the mobile handset 1210. In some examples, the audio output by the mobile handset 1210 to the user through the one or more speakers 1235B and/or other audio output devices may include, or be based on, audio recorded using the one or more microphones.

The mobile handset 1210 may use the display 1240 on the front surface 1220 as a pass-through display. For instance, the display 1240 may display output images, such as processed image data (e.g., a 3D occupancy prediction map such as the 3D occupancy prediction map 455). The output images can be based on the images (e.g., from the image sensor 130) captured by the third camera 1230C and/or the fourth camera 1230D, for example with the processed image data (e.g., a 3D occupancy prediction map such as the 3D occupancy prediction map 455) overlaid. The first camera 1230A and/or the second camera 1230B can capture images of the user's eyes (and/or other portions of the user) before, during, and/or after the display of the output images with the processed content on the display 1240. This way, the sensor data from the first camera 1230A and/or the second camera 1230B can capture reactions to the processed content by the user's eyes (and/or other portions of the user).

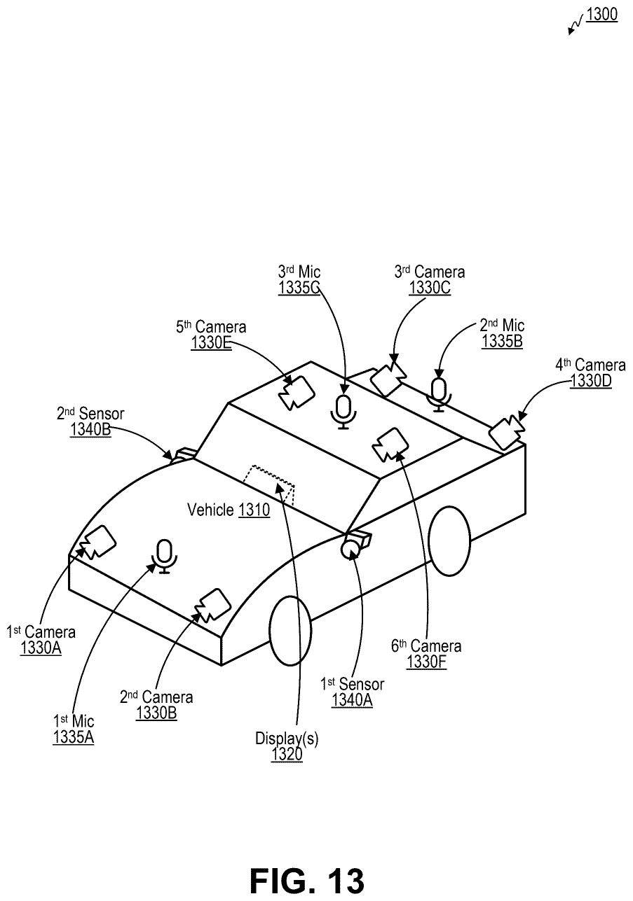

FIG. 13 is a perspective diagram 1300 illustrating a vehicle 1310 that includes various sensors and that can be used as part of an imaging system (e.g., imaging system 300, imaging system 400, imaging system 700). The vehicle 1310 may be an example of an imaging system 700. The vehicle 1310 may be, for example, an automobile, a truck, a bus, a train, a ground-based vehicle, an airplane, a helicopter, an aircraft, an aerial vehicle, a boat, a submarine, a watercraft, an underwater vehicle, a hovercraft, or a combination thereof. In some examples, the vehicle 1310 may be manned. In some examples, the vehicle 1310 may be unmanned, autonomous, and/or semi-autonomous. In some examples, the vehicle may be at least partially controlled and/or used with sub-systems of the vehicle 1310, such as an Advanced Driver Assistance System (ADAS) of the vehicle 1310, In-Vehicle Infotainment (IVI) systems of the vehicle 1310, autonomous driving systems of the vehicle 1310, semi-autonomous driving systems of the vehicle 1310, a vehicle electronic control unit (ECU) 930 of the vehicle 1310, or a combination thereof.

The vehicle 1310 includes a display 1320. The vehicle 1310 includes various sensors, all of which can be examples of the sensor(s) 205. The vehicle 1310 includes a first camera 1330A and a second camera 1330B at the front, a third camera 1330C and a fourth camera 1330D at the rear, and a fifth camera 1330E and a sixth camera 1330F on the top. The vehicle 1310 includes a first microphone 1335A at the front, a second microphone 1335B at the rear, and a third microphone 1335C at the top. The vehicle 1310 includes a first sensor 1340A on one side (e.g., adjacent to one rear-view mirror) and a second sensor 1340B on another side (e.g., adjacent to another rear-view mirror). The first sensor 1340A and the second sensor 1340B may include cameras, microphones, RADAR sensors, LIDAR sensors, or any other types of sensors(s) 205 described herein. In some examples, the vehicle 1310 may include additional sensor(s) 205 in addition to the sensors illustrated in FIG. 13. In some examples, the vehicle 1310 may be missing some of the sensors that are illustrated in FIG. 13.

In some examples, the display 1320 of the vehicle 1310 displays one or more output images toward a user of the vehicle 1310 (e.g., a driver and/or one or more passengers of the vehicle 1310). In some examples, the output images can include a 3D occupancy prediction map such as the 3D occupancy prediction map 455. The output images can be based on the images captured by the first camera 1530A, the second camera 1530B, the third camera 1530C, the fourth camera 1530D, the fifth camera 1530E, the sixth camera 1530F, the first sensor 1540A, and/or the second sensor 1540B, for example with the virtual content (e.g., a 3D occupancy prediction map such as the 3D occupancy prediction map 455) overlaid.

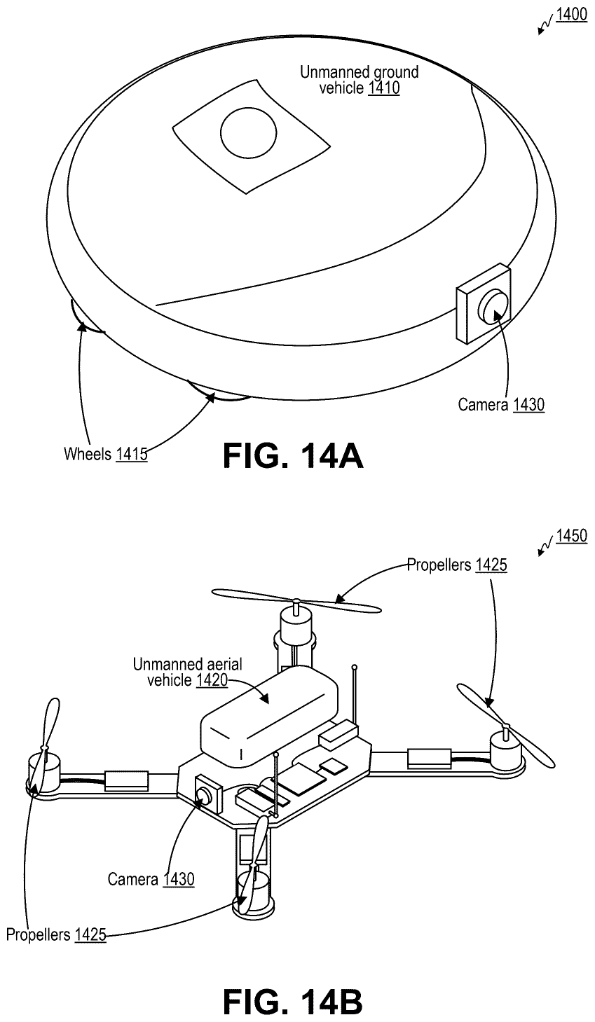

FIG. 14A is a perspective diagram 1400 illustrating an unmanned ground vehicle (UGV) 1410 that can be used as part of an imaging system (e.g., imaging system 300, imaging system 400, imaging system 700). The UGV 1410 illustrated in the perspective diagram 1400 of FIG. 14A may be an example of an imaging system. The UGV 1410 includes a camera 1430 along a front surface of the UGV 1410. In some examples, the UGV 1410 may include one or more additional cameras in addition to the camera 1430. In some examples, the UGV 1410 may include one or more additional sensors in addition to the camera 1430. The UGV 1410 includes multiple wheels 1415 along a bottom surface of the UGV 1410. The wheels 1415 may act as a conveyance of the UGV 1410, and may be motorized using one or more motors that may be actuated by a movement actuator of the UGV 1410. The movement actuator, the motors, and thus the wheels 1415, may be actuated to move the UGV 1410 along a path.

FIG. 14B is a perspective diagram 1450 illustrating an unmanned aerial vehicle (UAV) 1420 that can be used as part of an imaging system (e.g., imaging system 300, imaging system 400, imaging system 700). The UAV 1420 illustrated in the perspective diagram 1450 of FIG. 14B may be an example of an imaging system. The UAV 1420 includes a camera 1430 along a front portion of a body of the UAV 1420. In some examples, the UAV 1420 may include one or more additional cameras in addition to the camera 1430. In some examples, the UAV 1420 may include one or more additional sensors in addition to the camera 1430. The UAV 1420 includes multiple propellers 1425 along the top of the UAV 1420. The propellers 1425 may be spaced apart from the body of the UAV 1420 by one or more appendages to prevent the propellers 1425 from snagging on circuitry on the body of the UAV 1420 and/or to prevent the propellers 1425 from occluding the view of the camera 1430. The propellers 1425 may act as a conveyance of the UAV 1420, and may be motorized using one or more motors that may be actuated by a movement actuator of the UAV 1420. The movement actuator, the motors, and thus the propellers 1425, may be actuated to move the UAV 1420 along a path.

Where the imaging system is a vehicle, such as the vehicle 705, the vehicle 1310, the UGV 1410, and/or UAV 1420, the imaging system can include a simultaneous localization and mapping (SLAM) engine (e.g., a visual SLAM (SLAM) engine), a path or route planning engine, and/or a movement actuator. The SLAM engine can locate the vehicle in the environment and can map the environment, the path planning engine may generate a path or route along which the vehicle is to move, and the movement actuator can actuate wheels, propellors, legs, and/or other conveyance actuators to move the vehicle along the planned path or route. In some examples, path planning engine may use a Dijkstra algorithm to plan the path. In some examples, the path planning engine may include stationary obstacle avoidance and/or moving obstacle avoidance in planning the path. In some examples, the path planning engine may include determinations as to how to best move the vehicle from a first pose to a second pose in planning the path. In some examples, the path planning engine may plan a path that is optimized to reach and observe every portion of a first region of an environment (e.g., a first set of one or more rooms in the environment) before moving on to a second region of the environment (e.g., the second set of one or more rooms of the environment) in planning the path. In some examples, the path planning engine may plan a path that is optimized to reach and observe a predetermined set of rooms in an environment (e.g., every room in the environment) as quickly as possible. In some examples, the path planning engine may plan a path that returns to a previously-observed room to observe a particular feature again to improve one or more map points corresponding the feature in the local map and/or global map. In some examples, the path planning engine may plan a path that returns to a previously-observed room to observe a portion of the previously-observed room that lacks map points in the local map and/or global map to see if any features can be observed in that portion of the room. The movement actuator may actuate one or more motors to actuate a motorized conveyance (e.g., the wheels 1415 or the propellers 1425) to move the vehicle along the path planned by the path planning engine.

In some cases, the propellers 1425 of the UAV 1420, or another portion of a vehicle (e.g., an antenna), may partially occlude the view of one of the one or more cameras in some images captured by the one or more cameras. In some examples, this partial occlusion may be masked out of any images in which the partial occlusion appears, for example as in a masking operation.

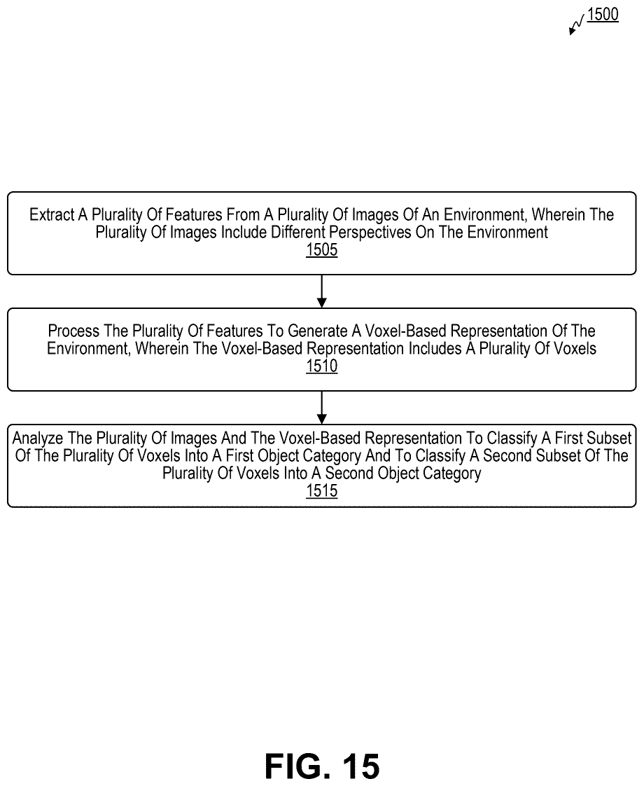

FIG. 15 is a flow diagram illustrating a process 1500 for imaging. The process 1500 may be performed by an imaging system. In some examples, the imaging system can include, for example, the image capture and processing system 100, the image capture device 105A, the image processing device 105B, the image processor 150, the ISP 154, the host processor 152, the imaging system 300, the imaging system 400, the imaging system 700, the ML system 900, the neural network 1000, the HMD 1110, the mobile handset 1210, the vehicle 1310, the UGV 1410, the UAV 1420, the computing system 1600, the processor 1610, an apparatus, a system, a non-transitory computer-readable medium coupled to a processor, or a combination thereof.

At operation 1505, the imaging system (or at least one subsystem thereof) is configured to, and can, extract a plurality of features from the plurality of images of an environment. The plurality of images include different perspectives on the environment. Examples of the plurality of images include images captured using the image capture and processing system 100, the image 210, the image 220, the input(s) 305, the images 310, the input(s) 405, the images 410, the image 505, the 2D depth map 515, the 2D semantic map 520, the image 525, the surface normal 535, the image 540, the local planar prior 550, the image 555, the edge prior 565, the images 720A-720F, the images 805A-805D, the input(s) 905, the images 910, image(s) input into the input layer 1010, images from any of the cameras 1130A-1130D, images from any of the cameras 1230A-1230D, images from any of the cameras 1330A-1330F, images from any of the sensors 1140A-1140B, images from the camera 1430, any other images discussed herein, images from any other camera or sensor discussed herein, or a combination thereof. Examples of the plurality of features include features extracted via the feature extraction 430, features in the 2D feature maps 605A-605D, features in the 3D feature volume 610, and/or the feature(s) 932. Examples of the perspectives include the perspectives 320, the perspectives 420, the different perspectives associated with each of the 2D feature maps 605A-605D, the different respective perspectives of each of the images 705A-705F, the perspectives 810A-810D, the different respective perspectives from each of the cameras 1130A-1130D the different respective perspectives from each of the cameras 1230A-1230D, the different respective perspectives from each of the cameras 1330A-1330F, the different respective perspectives from each of the sensors 1140A-1140B, or a combination thereof.

In some examples, the plurality of images are captured using one or more cameras. In some examples, the imaging system includes the one or more cameras. Examples of the one or more cameras include the image capture and processing system 100, the sensors 710A-710F, the cameras 1130A-1130D, the cameras 1230A-1230D, the cameras 1330A-1330F, the sensors 1140A-1140B, the camera 1430, any other images discussed herein, images from any other camera or sensor discussed herein, or a combination thereof.

In some examples, extracting the plurality of features from the plurality of images (as in operation 1505) includes processing the plurality of images using a trained machine learning model (e.g., ML model(s) 335, ML model(s) associated with the feature extraction 430, ML model(s) 925), for instance as in the ML model(s) 925 processing the images 910 to extract the feature(s) 932. In some examples, the imaging system (or at least one subsystem thereof) is configured to, and can, further train (e.g., update 955) the trained machine learning model (e.g., updating and/or improving the accuracy of the trained machine learning model in generating one or more of the different types of output(s) 930) based on feedback (e.g., feedback 950) associated with a classification (e.g., of the classifications of operation 1515) of at least one of the plurality of voxels.

In some examples, the imaging system (or at least one subsystem thereof) is configured to, and can, analyze the plurality of images and the voxel-based representation to generate (e.g., via the ML model(s) 335, the 2D depth map generator 460, and/or the ML model(s) 925) a two-dimensional depth map (e.g., 2D depth maps 465, 2D depth map 515, depth map(s) 940) of the environment, and further train (e.g., update 955) the trained machine learning model (e.g., updating and/or improving the accuracy of the trained machine learning model in generating one or more of the different types of output(s) 930) based on feedback (e.g., feedback 950) associated with the two-dimensional depth map. In some examples, the imaging system (or at least one subsystem thereof) is configured to, and can, analyze the plurality of images and the voxel-based representation to generate (e.g., via the ML model(s) 335, the 2D semantic map generator 470, and/or the ML model(s) 925) a two-dimensional semantic map (e.g., 2D semantic maps 475, 2D semantic map 520, semantic map(s) 942) of the environment, and further train (e.g., update 955) the trained machine learning model (e.g., updating and/or improving the accuracy of the trained machine learning model in generating one or more of the different types of output(s) 930) based on feedback (e.g., feedback 950) associated with the two-dimensional semantic map.

At operation 1510, the imaging system (or at least one subsystem thereof) is configured to, and can, process the plurality of features to generate a voxel-based representation of the environment. The voxel-based representation includes a plurality of voxels. Examples of the voxel-based representation of the environment includes the 3D occupancy prediction map 345, the 3D voxel representation 440, the 3D occupancy prediction map 455, the 3D feature volume 610, the classified voxels 815A-815D, the voxel representation 934, another voxel-based representation discussed herein, or a combination thereof.

In some examples, generating the voxel-based representation of the environment (as in operation 1510) includes processing the plurality of features using a trained machine learning model, for instance as in the ML model(s) 925 processing the feature(s) 932 to generate the voxel representation 934. For instance, the trained machine learning model can perform the feature averaging 435. In some examples, the imaging system (or at least one subsystem thereof) is configured to, and can, further train (e.g., update 955) the trained machine learning model (e.g., updating and/or improving the accuracy of the trained machine learning model in generating one or more of the different types of output(s) 930) based on feedback (e.g., feedback 950) associated with a classification (e.g., of the classifications of operation 1515) of at least one of the plurality of voxels.

In some examples, the imaging system (or at least one subsystem thereof) is configured to, and can, analyze the plurality of images and the voxel-based representation to generate (e.g., via the ML model(s) 335, the 2D depth map generator 460, and/or the ML model(s) 925) a two-dimensional depth map (e.g., 2D depth maps 465, 2D depth map 515, depth map(s) 940) of the environment, and further train (e.g., update 955) the trained machine learning model (e.g., updating and/or improving the accuracy of the trained machine learning model in generating one or more of the different types of output(s) 930) based on feedback associated with the two-dimensional depth map. In some examples, the imaging system (or at least one subsystem thereof) is configured to, and can, analyze the plurality of images and the voxel-based representation to generate (e.g., via the ML model(s) 335, the 2D semantic map generator 470, and/or the ML model(s) 925) a two-dimensional semantic map (e.g., 2D semantic maps 475, 2D semantic map 520, semantic map(s) 942) of the environment, and further train (e.g., update 955) the trained machine learning model (e.g., updating and/or improving the accuracy of the trained machine learning model in generating one or more of the different types of output(s) 930) based on feedback (e.g., feedback 950) associated with the two-dimensional semantic map.

In some examples, generating the voxel-based representation of the environment (as in operation 1510) includes processing the plurality of features using a plurality of layers of a trained machine learning model, the plurality of layers lacking cross-attention. For instance, at least one model of the ML model(s) 925 that processes the feature(s) 932 to generate the voxel representation 934 can lack cross-attention.

In some examples, generating the voxel-based representation of the environment (as in operation 1510) includes performing feature averaging (e.g., feature averaging 435) using the plurality of features based on the different perspectives. In some examples, the feature averaging is based on bilinear interpolation.

At operation 1515, the imaging system (or at least one subsystem thereof) is configured to, and can, analyze the plurality of images and the voxel-based representation to classify a first subset of the plurality of voxels into a first object category and to classify a second subset of the plurality of voxels into a second object category. Examples of the classification of operation 1515 includes the generation of the 3D occupancy prediction map 345, the classification of voxels from the 3D voxel representation 440 (e.g., via the 3D prediction generator 450) to generate the 3D occupancy prediction map 455, the classified voxels 815A-815D, the classification(s) 936, or a combination thereof.

In some examples, classifying the first subset into the first object category and to classify the second subset into the second object category (as in operation 1515) includes analyzing the plurality of images (e.g., images 410, images 910) and the voxel-based representation (e.g., 3D voxel representation 440, voxel representation 934 as one of the previous output(s) 915) using a trained machine learning model (e.g., 3D prediction generator 450, ML model(s) 925). In some examples, the imaging system (or at least one subsystem thereof) is configured to, and can, further train (e.g., update 955) the trained machine learning model (e.g., updating and/or improving the accuracy of the trained machine learning model in generating one or more of the different types of output(s) 930) based on feedback (e.g., feedback 950) associated with a classification (e.g., of the classifications of operation 1515) of at least one of the plurality of voxels.

In some examples, the imaging system (or at least one subsystem thereof) is configured to, and can, analyze the plurality of images and the voxel-based representation to generate (e.g., via the ML model(s) 335, the 2D depth map generator 460, and/or the ML model(s) 925) a two-dimensional depth map (e.g., 2D depth maps 465, 2D depth map 515, depth map(s) 940) of the environment, and further train (e.g., update 955) the trained machine learning model (e.g., updating and/or improving the accuracy of the trained machine learning model in generating one or more of the different types of output(s) 930) based on feedback associated with the two-dimensional depth map. In some examples, the imaging system (or at least one subsystem thereof) is configured to, and can, analyze the plurality of images and the voxel-based representation to generate (e.g., via the ML model(s) 335, the 2D semantic map generator 470, and/or the ML model(s) 925) a two-dimensional semantic map (e.g., 2D semantic maps 475, 2D semantic map 520, semantic map(s) 942) of the environment, and further train (e.g., update 955) the trained machine learning model (e.g., updating and/or improving the accuracy of the trained machine learning model in generating one or more of the different types of output(s) 930) based on feedback (e.g., feedback 950) associated with the two-dimensional semantic map.

In some examples, the first object category corresponds to occupied voxels, and the second object category corresponds to free voxels. In some examples, the first object category corresponds to a first material type, and the second object category corresponds to a second material type. Examples of different material types include driveable surfaces, terrain, vegetation, structures, cars, trucks, people, non-vehicle paths, barriers, bicycles, buses, trains, construction vehicles, motorcycles, traffic cones, trailers, other flat surfaces, unobserved areas, general objects, out-of-vocabulary objects, any other material types discussed herein, any other object types discussed herein, any other categories discussed herein, or a combination thereof.

In some examples, the processes described herein (e.g., the respective processes of FIGS. 1, 2, 3, 4, 5, 6, 7, 8, 9, 10, 11, 12, 13, 14, the process 1500 of FIG. 15, and/or other processes described herein) may be performed by a computing device or apparatus. In some examples, the processes described herein can be performed by the image capture and processing system 100, the image capture device 105A, the image processing device 105B, the image processor 150, the ISP 154, the host processor 152, the imaging system 300, the imaging system 400, the imaging system 700, the ML system 900, the neural network 1000, the HMD 1110, the mobile handset 1210, the vehicle 1310, the UGV 1410, the UAV 1420, the imaging system that performs the process 1500, the computing system 1600, the processor 1610, an apparatus, a system, a non-transitory computer-readable medium coupled to a processor, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

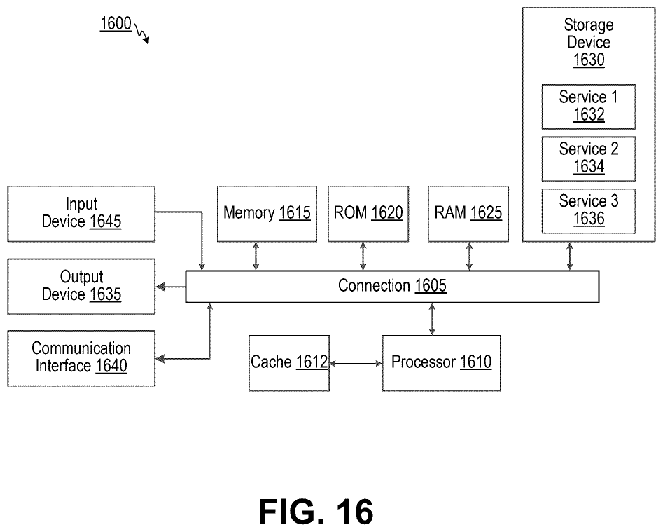

FIG. 16 is a diagram illustrating an example of a system for implementing certain aspects of the present technology. In particular, FIG. 16 illustrates an example of computing system 1600, which can be for example any computing device making up internal computing system, a remote computing system, a camera, or any component thereof in which the components of the system are in communication with each other using connection 1605. Connection 1605 can be a physical connection using a bus, or a direct connection into processor 1610, such as in a chipset architecture. Connection 1605 can also be a virtual connection, networked connection, or logical connection.

In some aspects, computing system 1600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1600 includes at least one processing unit (CPU or processor) 1610 and connection 1605 that couples various system components including system memory 1615, such as read-only memory (ROM) 1620 and random access memory (RAM) 1625 to processor 1610. Computing system 1600 can include a cache 1612 of high-speed memory connected directly with, in close proximity to, or integrated as part of processor 1610.

Processor 1610 can include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms. In some instances, multimodal systems can enable a user to provide multiple types of input/output to communicate with computing system 1600. Computing system 1600 can include communications interface 1640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1602.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1630 can include software services, servers, services, etc., that when the code that defines such software is executed by the processor 1610, it causes the system to perform a function. In some aspects, a hardware service that performs a particular function can include the software component stored in a computer-readable medium in connection with the necessary hardware components, such as processor 1610, connection 1605, output device 1635, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus to process image data, the apparatus comprising: one or more memories configured to store a plurality of images; and one or more processors coupled to the one or more memories and configured to: extract a plurality of features from the plurality of images of an environment, wherein the plurality of images include different perspectives on the environment; process the plurality of features to generate a voxel-based representation of the environment, wherein the voxel-based representation includes a plurality of voxels; and analyze the plurality of images and the voxel-based representation to classify a first subset of the plurality of voxels into a first object category and to classify a second subset of the plurality of voxels into a second object category.

Aspect 2. The apparatus of Aspect 1, wherein, to extract the plurality of features from the plurality of images, the one or more processors are configured to process the plurality of images using a trained machine learning model.

Aspect 3. The apparatus of Aspect 2, wherein the one or more processors are configured to: further train the trained machine learning model based on feedback associated with a classification of at least one of the plurality of voxels.

Aspect 4. The apparatus of any of Aspects 2 or 3, wherein the one or more processors are configured to: analyze the plurality of images and the voxel-based representation to generate a two-dimensional depth map of the environment; and further train the trained machine learning model based on feedback associated with the two-dimensional depth map.

Aspect 5. The apparatus of any of Aspects 2 to 4, wherein the one or more processors are configured to: analyze the plurality of images and the voxel-based representation to generate a two-dimensional semantic map of the environment; and further train the trained machine learning model based on feedback associated with the two-dimensional semantic map.

Aspect 6. The apparatus of any of Aspects 1 to 5, wherein, to generate the voxel-based representation of the environment, the one or more processors are configured to process the plurality of features using a trained machine learning model.

Aspect 7. The apparatus of Aspect 6, wherein the one or more processors are configured to: further train the trained machine learning model based on feedback associated with a classification of at least one of the plurality of voxels.

Aspect 8. The apparatus of any of Aspects 6 or 7, wherein the one or more processors are configured to: analyze the plurality of images and the voxel-based representation to generate a two-dimensional depth map of the environment; and further train the trained machine learning model based on feedback associated with the two-dimensional depth map.

Aspect 9. The apparatus of any of Aspects 6 to 8, wherein the one or more processors are configured to: analyze the plurality of images and the voxel-based representation to generate a two-dimensional semantic map of the environment; and further train the trained machine learning model based on feedback associated with the two-dimensional semantic map.

Aspect 10. The apparatus of any of Aspects 1 to 9, wherein, to generate the voxel-based representation of the environment, the one or more processors are configured to process the plurality of features using a plurality of layers of a trained machine learning model, wherein the plurality of layers lack cross-attention.

Aspect 11. The apparatus of any of Aspects 1 to 10, wherein, to generate the voxel-based representation of the environment, the one or more processors are configured to perform feature averaging using the plurality of features based on the different perspectives.

Aspect 12. The apparatus of Aspect 11, wherein the feature averaging is based on bilinear interpolation.

Aspect 13. The apparatus of any of Aspects 1 to 12, wherein, to classify the first subset into the first object category and to classify the second subset into the second object category, the one or more processors are configured to analyze the plurality of images and the voxel-based representation using a trained machine learning model.

Aspect 14. The apparatus of Aspect 13, wherein the one or more processors are configured to: further train the trained machine learning model based on feedback associated with a classification of at least one of the plurality of voxels.

Aspect 15. The apparatus of any of Aspects 13 or 14, wherein the one or more processors are configured to: analyze the plurality of images and the voxel-based representation to generate a two-dimensional depth map of the environment; and further train the trained machine learning model based on feedback associated with the two-dimensional depth map.

Aspect 16. The apparatus of any of Aspects 13 to 15, wherein the one or more processors are configured to: analyze the plurality of images and the voxel-based representation to generate a two-dimensional semantic map of the environment; and further train the trained machine learning model based on feedback associated with the two-dimensional semantic map.

Aspect 17. The apparatus of any of Aspects 1 to 16, further comprising one or more cameras configured to capture the plurality of images.

Aspect 18. The apparatus of any of Aspects 1 to 17, wherein the first object category corresponds to occupied voxels, and wherein the second object category corresponds to free voxels.

Aspect 19. The apparatus of any of Aspects 1 to 18, wherein the first object category corresponds to a first material type, and wherein the second object category corresponds to a second material type.

Aspect 20. A method to process image data, the method comprising: extracting a plurality of features from a plurality of images of an environment, wherein the plurality of images include different perspectives on the environment; processing the plurality of features to generate a voxel-based representation of the environment, wherein the voxel-based representation includes a plurality of voxels; and analyzing the plurality of images and the voxel-based representation to classify a first subset of the plurality of voxels into a first object category and to classify a second subset of the plurality of voxels into a second object category.

Aspect 21. The method of Aspect 20, wherein extracting the plurality of features from the plurality of images includes processing the plurality of images using a trained machine learning model.

Aspect 22. The method of Aspect 21, further comprising: further training the trained machine learning model based on feedback associated with a classification of at least one of the plurality of voxels.

Aspect 23. The method of any of Aspects 21 or 22, further comprising: analyzing the plurality of images and the voxel-based representation to generate a two-dimensional depth map of the environment; and further training the trained machine learning model based on feedback associated with the two-dimensional depth map.

Aspect 24. The method of any of Aspects 21 to 23, further comprising: analyzing the plurality of images and the voxel-based representation to generate a two-dimensional semantic map of the environment; and further training the trained machine learning model based on feedback associated with the two-dimensional semantic map.

Aspect 25. The method of any of Aspects 20 to 24, wherein generating the voxel-based representation of the environment includes processing the plurality of features using a trained machine learning model.

Aspect 26. The method of Aspect 25, further comprising: further training the trained machine learning model based on feedback associated with a classification of at least one of the plurality of voxels.

Aspect 27. The method of any of Aspects 25 or 26, further comprising: analyzing the plurality of images and the voxel-based representation to generate a two-dimensional depth map of the environment; and further training the trained machine learning model based on feedback associated with the two-dimensional depth map.

Aspect 28. The method of any of Aspects 25 to 27, further comprising: analyzing the plurality of images and the voxel-based representation to generate a two-dimensional semantic map of the environment; and further training the trained machine learning model based on feedback associated with the two-dimensional semantic map.

Aspect 29. The method of any of Aspects 20 to 28, wherein generating the voxel-based representation of the environment includes processing the plurality of features using a plurality of layers of a trained machine learning model, wherein the plurality of layers lack cross-attention.

Aspect 30. The method of any of Aspects 20 to 29, wherein generating the voxel-based representation of the environment includes performing feature averaging using the plurality of features based on the different perspectives.

Aspect 31. The method of any of Aspects 30, wherein the feature averaging is based on bilinear interpolation.

Aspect 32. The method of any of Aspects 20 to 31, wherein classifying the first subset into the first object category and to classify the second subset into the second object category includes analyzing the plurality of images and the voxel-based representation using a trained machine learning model.

Aspect 33. The method of Aspect 32, further comprising: further training the trained machine learning model based on feedback associated with a classification of at least one of the plurality of voxels.

Aspect 34. The method of any of Aspects 32 or 33, further comprising: analyzing the plurality of images and the voxel-based representation to generate a two-dimensional depth map of the environment; and further training the trained machine learning model based on feedback associated with the two-dimensional depth map.

Aspect 35. The method of any of Aspects 32 to 34, further comprising: analyzing the plurality of images and the voxel-based representation to generate a two-dimensional semantic map of the environment; and further training the trained machine learning model based on feedback associated with the two-dimensional semantic map.

Aspect 36. The method of any of Aspects 20 to 35, wherein the plurality of images are captured using one or more cameras.

Aspect 37. The method of any of Aspects 20 to 36, wherein the first object category corresponds to occupied voxels, and wherein the second object category corresponds to free voxels.

Aspect 38. The method of any of Aspects 20 to 37, wherein the first object category corresponds to a first material type, and wherein the second object category corresponds to a second material type.

Aspect 39. A non-transitory computer-readable medium having stored thereon instructions that, when executed by one or more processors, cause the one or more processors to perform operations according to any of Aspects 1 to 38.

Aspect 40. An apparatus for sensor data processing, the apparatus comprising one or more means for performing operations according to any of Aspects 1 to 38.

What is claimed is:

1. An apparatus to process image data, the apparatus comprising:
one or more memories configured to store a plurality of images; and
one or more processors coupled to the one or more memories and configured to:
extract a plurality of features from the plurality of images of an environment, wherein the plurality of images include different perspectives on the environment;
process the plurality of features to generate a voxel-based representation of the environment, wherein the voxel-based representation includes a plurality of voxels; and
analyze the plurality of images and the voxel-based representation to classify a first subset of the plurality of voxels into a first object category and to classify a second subset of the plurality of voxels into a second object category.

2. The apparatus of claim 1, wherein, to extract the plurality of features from the plurality of images, the one or more processors are configured to process the plurality of images using a trained machine learning model.

3. The apparatus of claim 2, wherein the one or more processors are configured to:
further train the trained machine learning model based on feedback associated with a classification of at least one of the plurality of voxels.

4. The apparatus of claim 2, wherein the one or more processors are configured to:
analyze the plurality of images and the voxel-based representation to generate a two-dimensional depth map of the environment; and
further train the trained machine learning model based on feedback associated with the two-dimensional depth map.

5. The apparatus of claim 2, wherein the one or more processors are configured to:
analyze the plurality of images and the voxel-based representation to generate a two-dimensional semantic map of the environment; and
further train the trained machine learning model based on feedback associated with the two-dimensional semantic map.

6. The apparatus of claim 1, wherein, to generate the voxel-based representation of the environment, the one or more processors are configured to process the plurality of features using a trained machine learning model.

7. The apparatus of claim 6, wherein the one or more processors are configured to:
further train the trained machine learning model based on feedback associated with a classification of at least one of the plurality of voxels.

8. The apparatus of claim 6, wherein the one or more processors are configured to:
analyze the plurality of images and the voxel-based representation to generate a two-dimensional depth map of the environment; and
further train the trained machine learning model based on feedback associated with the two-dimensional depth map.

9. The apparatus of claim 6, wherein the one or more processors are configured to:
analyze the plurality of images and the voxel-based representation to generate a two-dimensional semantic map of the environment; and
further train the trained machine learning model based on feedback associated with the two-dimensional semantic map.

10. The apparatus of claim 1, wherein, to generate the voxel-based representation of the environment, the one or more processors are configured to process the plurality of features using a plurality of layers of a trained machine learning model, wherein the plurality of layers lack cross-attention.

11. The apparatus of claim 1, wherein, to generate the voxel-based representation of the environment, the one or more processors are configured to perform feature averaging using the plurality of features based on the different perspectives.

12. The apparatus of claim 11, wherein the feature averaging is based on bilinear interpolation.

13. The apparatus of claim 1, wherein, to classify the first subset into the first object category and to classify the second subset into the second object category, the one or more processors are configured to analyze the plurality of images and the voxel-based representation using a trained machine learning model.

14. The apparatus of claim 13, wherein the one or more processors are configured to:
further train the trained machine learning model based on feedback associated with a classification of at least one of the plurality of voxels.

15. The apparatus of claim 13, wherein the one or more processors are configured to:
analyze the plurality of images and the voxel-based representation to generate a two-dimensional depth map of the environment; and
further train the trained machine learning model based on feedback associated with the two-dimensional depth map.

16. The apparatus of claim 13, wherein the one or more processors are configured to:
analyze the plurality of images and the voxel-based representation to generate a two-dimensional semantic map of the environment; and
further train the trained machine learning model based on feedback associated with the two-dimensional semantic map.

17. The apparatus of claim 1, further comprising one or more cameras configured to capture the plurality of images.

18. The apparatus of claim 1, wherein the first object category corresponds to occupied voxels, and wherein the second object category corresponds to free voxels.

19. The apparatus of claim 1, wherein the first object category corresponds to a first material type, and wherein the second object category corresponds to a second material type.

20. A method to process image data, the method comprising:
extracting a plurality of features from a plurality of images of an environment, wherein the plurality of images include different perspectives on the environment;
processing the plurality of features to generate a voxel-based representation of the environment, wherein the voxel-based representation includes a plurality of voxels; and
analyzing the plurality of images and the voxel-based representation to classify a first subset of the plurality of voxels into a first object category and to classify a second subset of the plurality of voxels into a second object category.
